(19) United States
(12) Patent Application Publication
(10) Pub. No.: US 2017/0142049 A1
(43) Pub. Date: May 18, 2017

(54) METHOD AND DEVICE FOR PROCESSING AND DISPLAYING EMAILS

(71) Applicant: YANDEX EUROPE AG, Luzern (CH)

(72) Inventors: Egor Vladimirovitch GANIN, Podolsky district (RU); Andrei Igorevich SUNDIEV, Moscow (RU)

(21) Appl. No.: 15/340,078

(22) Filed: Nov. 1, 2016

(30) Foreign Application Priority Data
Nov. 16, 2015 (RU) 2015149041

(51) Int. Cl. H04L 12/58; H04L 29/06

(52) U.S. Cl. CPC H04L 51/12; H04L 51/22; H04L 51/16; H04L 67/42

(57) ABSTRACT

A method of processing emails, the method being executed on a client device, the client device being connected to a server, the server hosting an email service, the method comprising: acquiring, by the client device, a plurality of emails from the server, each email within the plurality of emails comprising a respective email-inherent data, each email-inherent data being structured by the email service according to an email-native protocol; generating, by the client device, a grouped message element, the grouped message element being associated with a group of emails within the plurality of emails; generating, by the client device, an individual message element; displaying, by the client device, the grouped message element and the individual message element concurrently such that the grouped message element is visually distinguishable from the individual message element.

### CROSS-REFERENCE

The present application claims priority to Russian Patent Application No. 2015149041, filed Nov. 16, 2015, entitled “METHOD AND DEVICE FOR PROCESSING AND DISPLAYING EMAILS”, the entirety of which is incorporated herein by reference.

### FIELD

The present technology relates to email display and, more specifically, to email processing.

### BACKGROUND

Electronic mail messages, usually shortened as ‘email’ or ‘e-mail’ or “email-message”, have become a very common means of communication. Indeed, in many situations, email messaging has replaced the standard post letter, the telephone and the facsimile as the preferred means of communication.

However, emails have some drawbacks: users have no way of knowing whether the email recipient is online at the particular moment the email was sent; if two people were emailing back and forth they may spend valuable time going through steps to read, reply and send messages. Mainly due to these drawbacks, one of the more popular innovations that resulted from this increased interest in and use of the Internet is instant messaging. Instant messaging, or IM, is a text-based tool that allows users to carry on conversations when connected to the Internet.

Generally, instant messaging allows quickly sending text messages between parties. Instant messaging programs may display text messages to users in a convivial manner and also allow users to exchange links to websites, share files by sending them directly to people on the user's contact list, and many other features. However, instant messaging has some drawbacks as well. For example, in most of the cases, an instant messaging service must be associated with a phone number of a user.

### SUMMARY

Developers of the present technology have developed embodiments of the present technology based on their appreciation that both email and instant messaging communications may offer complementary advantages, yet individually they are suferring from certain disadvantages. In other words, developers of the present technology have developed embodiments of the present technology based on their realization that implementing a hybrid form of communication between emails and instant messaging may have a positive effect on user experience during information exchange amongst a plurality of users. However, as previously alluded to, emails and instant messages are transmitted via different communicational platforms and, therefore, email and instant messaging communication systems are implemented in dissimilar manners.

It is an object of the present technology to ameliorate at least some of the inconveniences present in the prior art.

According to one aspect of the present technology, there is provided a method of processing emails wherein the method is executed on a client device and wherein the client device being connected to a server. the server hosts an email service and the method comprises: acquiring, by the client device, a plurality of emails from the server wherein each email within the plurality of emails comprises a respective email-inherent data and wherein each email-inherent data is structured by the email service according to an email-native protocol; generating, by the client device, a grouped message element wherein the grouped message element is associated with a group of emails within the plurality of emails and wherein the generating the grouped message element comprises determining, by the client device, that each email within the group of emails is associated with the grouped message element based on a grouping parameter within the respective email-inherent data of each email within the group of emails; generating, by the client device, an individual message element wherein the individual message element is associated with an individual email within the plurality of emails and wherein the generating the individual message element comprises determining, by the client device, that the individual email is not associated with the grouped message element based on the grouping parameter within the email-inherent data of the individual email; and displaying, by the client device, the grouped message element and the individual message element concurrently such that the grouped message element is visually distinguishable from the individual message element and wherein the displaying the grouped message element comprises displaying a portion of a most recent email within the group of emails and wherein the displaying the individual message element comprises displaying a portion of the individual email.

In some implementations of the method, the grouped message element is expandable for displaying a portion of each email within the group of emails associated with the grouped message element.

In some implementations of the method, wherein the plurality of emails comprises inbound emails and outbound emails, and wherein the group of emails comprises an inbound email and an outbound email. The displaying the portion of each email within the group of emails comprises displaying, by the client device, a portion of the inbound and the outbound email within the group of emails such that the portion of the inbound email is visually distinguishable from the portion of the outbound email.

In some implementations of the method, wherein the inbound emails are emails destined to a user of the email service and the outbound emails are emails originated from the user of the email service.

In some implementations of the method, wherein the email-native protocol is Simple Mail Transfer Protocol.

In some implementations of the method, wherein the determining that the group of emails within the plurality of emails are associated with the grouped message element based on the grouping parameter comprises determining, by the client device, the grouping parameter within the respective email-inherent data of each email within the group of emails.

In some implementations of the method, wherein the determining that the group of emails within the plurality of emails are associated with the grouped message element based on the grouping parameter further comprises parsing, by the client device, the respective email-inherent data of each email within the group of emails.

In some implementations of the method, wherein the determining that the group of emails within the plurality of emails is associated with the grouped message element is executed by the user.

In some implementations of the method, wherein the determining that the individual email within the plurality of emails is associated with the individual message element is executed by the user.

According to another aspect of the present technology, there is provided a method of processing emails wherein the method is executed in a system. The system includes: a communication network; a server hosting an email service wherein the server is connected to the communication network; a first client device associated with a first user of the email service, wherein the first client device is connected to the communication network; and a second client device associated with a second user of the email service, wherein the second client device is connected to the communication network. The method comprises: acquiring, by the server via the communication network, a plurality of emails, wherein each email within the plurality of emails comprises a respective email-inherent data; acquiring, by the first client device from the server via the communication network, the respective email-inherent data of each email within the plurality of emails, wherein each respective email-inherent data is structured by the email service according to an email-native protocol; generating, by the first client device, a grouped message element, wherein the grouped message element is associated with a group of emails within the plurality of emails and wherein the generating the grouped message element comprises determining, by the first client device, that each email within the group of emails is associated with the grouped message element based on a grouping parameter within the respective email-inherent data of each email within the group of emails; generating, by the first client device, an individual message element, wherein the individual message element being associated with an individual email within the plurality of emails and wherein the generating the individual message element comprises determining, by the first client device, that the individual email is not associated with the grouped message element based on the grouping parameter within the email-inherent data of the individual email; displaying, by the first client device to the first user, wherein the grouped message element and the individual message element concurrently such that the grouped message element is visually distinguishable from the individual message element and wherein the displaying the grouped message element comprises displaying, by the first client device, a portion of a most recent email within the group of emails and wherein the displaying the individual message element comprises displaying, by the first client device, a portion of the individual email; acquiring, by the second client device from the server via the communication network, the respective email-inherent data of each email within the plurality of emails, wherein each respective email-inherent data is structured by the email service according to the email-native protocol; and displaying, by the second client device to the second user, wherein each email within the plurality of emails in a respective email-style view based on the respective email-inherent data of each email within the plurality of emails.

According to another aspect of the present technology, there is provided a client device for processing emails, wherein the client device is connected to a server and wherein the server is hosting an email service. The client device is configured to: acquire a plurality of emails from the server, wherein each email within the plurality of emails comprises a respective email-inherent data and wherein each email-inherent data is structured by the email service according to an email-native protocol; generate a grouped message element, wherein the grouped message element is associated with a group of emails within the plurality of emails and wherein to generate the grouped message element comprises the client device configured to determine that each email within the group of emails is associated with the grouped message element based on a grouping parameter within the respective email-inherent data of each email within the group of emails; generate an individual message element, wherein the individual message element is associated with an individual email within the plurality of emails and wherein to generate the individual message element comprises the client device configured to determine that the individual email is not associated with the grouped message element based on the grouping parameter within the email-inherent data of the individual email; and display the grouped message element and the individual message element concurrently such that the grouped message element is visually distinguishable from the individual message element, wherein to display the grouped message element comprises the client device configured to display a portion of a most recent email within the group of emails and wherein to display the individual message element comprises the client device configured to display a portion of the individual email.

In some implementations of the client device, wherein the grouped message element is expandable for displaying a portion of each email within the group of emails associated with the grouped message element.

In some implementations of the client device, wherein the plurality of emails comprises inbound emails and outbound emails, and wherein the group of emails comprises an inbound email and an outbound email, and wherein to display the portion of each email within the group of emails comprises the client device configured to display a portion of the inbound and the outbound email within the group of emails such that the portion of the inbound email is visually distinguishable from the portion of the outbound email.

In some implementations of the client device, wherein the inbound emails are emails destined to a user of the email service and the outbound emails are emails originated from the user of the email service.

In some implementations of the client device, wherein the email-native protocol is Simple Mail Transfer Protocol.

In some implementations of the client device, wherein to determine that the group of emails within the plurality of emails are associated with the grouped message element based on the grouping parameter comprises the client device configured to determine the grouping parameter within the respective email-inherent data of each email within the group of emails.

In some implementations of the client device, wherein to determine that the group of emails within the plurality of emails are associated with the grouped message element based on the grouping parameter further comprises the client device configured to parse the respective email-inherent data of each email within the group of emails.

In some implementations of the client device, wherein to determine that the group of emails within the plurality of emails is associated with the grouped message element is executed by the user.

In some implementations of the client device, wherein to determining that the individual email within the plurality of emails is associated with the individual message element is executed by the user.

According to another aspect of the present technology, there is provided a method of processing emails, wherein the method is executed in a system. The system includes: a communication network; a server hosting an email service, wherein the server is connected to the communication network; a first client device associated with a first user of the email service, wherein the first client device is connected to the communication network and wherein the first client device is executing an e-mail interface of a first type; and a second client device associated with a second user of the email service, wherein the second client device is connected to the communication network and wherein the second client device is executing an e-mail interface of a second type. The first type is of a messenger style and the second type is of an e-mail style. The method comprises: hosting, a plurality of emails, wherein any given e-mail within the plurality of e-mails is (i) a first outgoing e-mail from the first client device to the second client device and (ii) a second outgoing e-mail from the second client device to the first client device, such that (i) the first outgoing e-mail from the first client device to the second client device is a first incoming e-mail from the first client device to the second client device and (ii) the second outgoing e-mail from the second client device to the first client device is a second incoming e-mail from the second client device to the first client device. Each email within the plurality of emails comprises a respective email-inherent data, wherein each respective email-inherent data is structured by the email service according to an email-native protocol. In response to a request by the first client device, the method comprises transmitting via the communication network at least a portion of the plurality of e-mails, wherein the portion includes at least one first outgoing e-mail and at least one second incoming message, and wherein said transmitting causes the first client device to execute: generating, by the first client device, a grouped message element, wherein the grouped message element is associated with a group of emails within the plurality of emails, and wherein the generating the grouped message element comprises determining, by the first client device, that each email within the group of emails is associated with the grouped message element based on a grouping parameter within the respective email-inherent data of each email within the group of emails; generating, by the first client device, an individual message element, wherein the individual message element is associated with an individual email within the plurality of emails, wherein the generating the individual message element comprises determining, by the first client device, that the individual email is not associated with the grouped message element based on the grouping parameter within the email-inherent data of the individual email; displaying, by the first client device to the first user, the grouped message element and the individual message element concurrently such that the grouped message element is visually distinguishable from the individual message element, wherein the displaying the grouped message element comprises displaying, by the first client device, a portion of a most recent email within the group of emails, wherein the displaying the individual message element comprises displaying, by the first client device, a portion of the individual email. In response to a request by the second client device, the method comprises transmitting via the communication network at least a portion of the plurality of e-mails, wherein the portion includes at least one second outgoing e-mail and at least one first incoming message, wherein said transmitting causes the second client device to execute: displaying, by the second client device to the second user, each email within the plurality of emails in a respective email-style view based on the respective email-inherent data of each email within the plurality of emails.

In the context of the present specification, a “server” is a computer program that is running on appropriate hardware and is capable of receiving requests (e.g. from client devices such as communication devices associated with e-mail receivers) over a network, and carrying out those requests, or causing those requests to be carried out. The hardware may be one physical computer or one physical computer system, but neither is required to be the case with respect to the present technology. In the present context, the use of the expression a “server” is not intended to mean that every task (e.g. received instructions or requests) or any particular task will have been received, carried out, or caused to be carried out, by the same server (i.e. the same software and/or hardware); it is intended to mean that any number of software elements or hardware devices may be involved in receiving/sending, carrying out or causing to be carried out any task or request, or the consequences of any task or request; and all of this software and hardware may be one server or multiple servers, both of which are included within the expression “at least one server”.

In the context of the present specification, “client device” and “communication device” are synonymous and designate any electronic device or computer hardware that is capable of running software appropriate to the relevant task at hand and is capable further of communicating with a server, either directly or through a network, by means of a wired connection including without limitation a cable or optical fiber connection, or by means of a wireless connection including without limitation a cellular, WiFi™ or Bluetooth™ connection. Thus, some (non-limiting) examples of client devices or communication devices include personal computers (desktops, laptops, netbooks, etc.), and mobile devices such as smartphones and tablets, as well as network equipment such as routers, switches, and gateways. It should be noted that a device acting as a client device or communication device in the present context is not precluded from acting as a server to other client devices or communication devices. The use of the expressions “a client device” and “a communication device” does not preclude multiple devices being used in receiving/sending, carrying out or causing to be carried out any task or request, or the consequences of any task or request, or steps of any method described herein.

In the context of the present specification, a “database” is any structured collection of data, irrespective of its particular structure, the database management software, or the computer hardware on which the data is stored, implemented or otherwise rendered available for use. A database may reside on the same hardware as the process that stores or makes use of the information stored in the database or it may reside on separate hardware, such as a dedicated server or plurality of servers.

In the context of the present specification, the expression “information” includes information of any nature or kind whatsoever capable of being stored in a database. Thus information includes, but is not limited to audiovisual works (images, movies, sound records, presentations etc.), data (location data, numerical data, etc.), text (opinions, comments, questions, messages, etc.), documents, spreadsheets, etc.

In the context of the present specification, the expression “component” is meant to include software (appropriate to a particular hardware context) that is both necessary and sufficient to achieve the specific function(s) being referenced.

In the context of the present specification, the expression “computer information storage medium” is intended to include media of any nature and kind whatsoever, including without limitation RAM, ROM, disks (CD-ROMs, DVDs, floppy disks, hard drivers, etc.), USB keys, solid state-drives, tape drives, etc. A plurality of components may be combined to form the computer information storage medium, including two or more media components of a same type and/or two or more media components of different types.

In the context of the present specification, the words “first”, “second”, “third”, etc. have been used as adjectives only for the purpose of allowing for distinction between the nouns that they modify from one another, and not for the purpose of describing any particular relationship between those nouns. Thus, for example, it should be understood that, the use of the terms “first server” and “third server” is not intended to imply any particular order, type, chronology, hierarchy or ranking (for example) of/between the server, nor is their use (by itself) intended imply that any “second server” must necessarily exist in any given situation. Further, as is discussed herein in other contexts, reference to a “first” element and a “second” element does not preclude the two elements from being the same actual real-world element. Thus, for example, in some instances, a “first” server and a “second” server may be the same software and/or hardware, in other cases they may be different software and/or hardware.

Implementations of the present technology each have at least one of the above-mentioned object and/or aspects, but do not necessarily have all of them. It should be understood that some aspects of the present technology that have resulted from attempting to attain the above-mentioned object may not satisfy this object and/or may satisfy other objects not specifically recited herein.

Additional and/or alternative features, aspects and advantages of implementations of the present technology will become apparent from the following description, the accompanying drawings and the appended claims.

### BRIEF DESCRIPTION OF THE DRAWINGS

For a better understanding of the present technology, as well as other aspects and further features thereof, reference is made to the following description which is to be used in conjunction with the accompanying drawings, where:

FIG. 1 depicts a system for processing emails as contemplated in some implementations of the present technology.

FIG. 2 depicts an email-style view of the first email as contemplated in some implementations of the present technology.

FIG. 3 depicts an email-style view of the second email as contemplated in some implementations of the present technology.

FIG. 4 depicts an email-style view of the third email as contemplated in some implementations of the present technology.

FIG. 5 depicts an email-style view of the fourth email as contemplated in some implementations of the present technology.

FIG. 6 depicts an email-style view of the fifth email as contemplated in some implementations of the present technology.

FIG. 7 depicts an embodiment of the first email interface executed by the first client device.

FIG. 8 depicts another embodiment of the first email interface executed by the first client device.

FIG. 9 depicts another embodiment of the first email interface executed by the first client device.

FIG. 10 depicts an email-style view of the sixth email as contemplated in some implementations of the present technology.

FIG. 11 depicts another embodiment of the first email interface executed by the first client device.

FIG. 12 depicts the respective email-inherent data of emails within the plurality of emails as contemplated is some implementations of the present technology.

FIG. 13 is a flowchart of a method of processing emails executed by the first client device in some embodiments of the present technology.

FIG. 14 is a flowchart of a method of processing emails executed by a system as contemplated in some implementations of the present technology.

### DETAILED DESCRIPTION

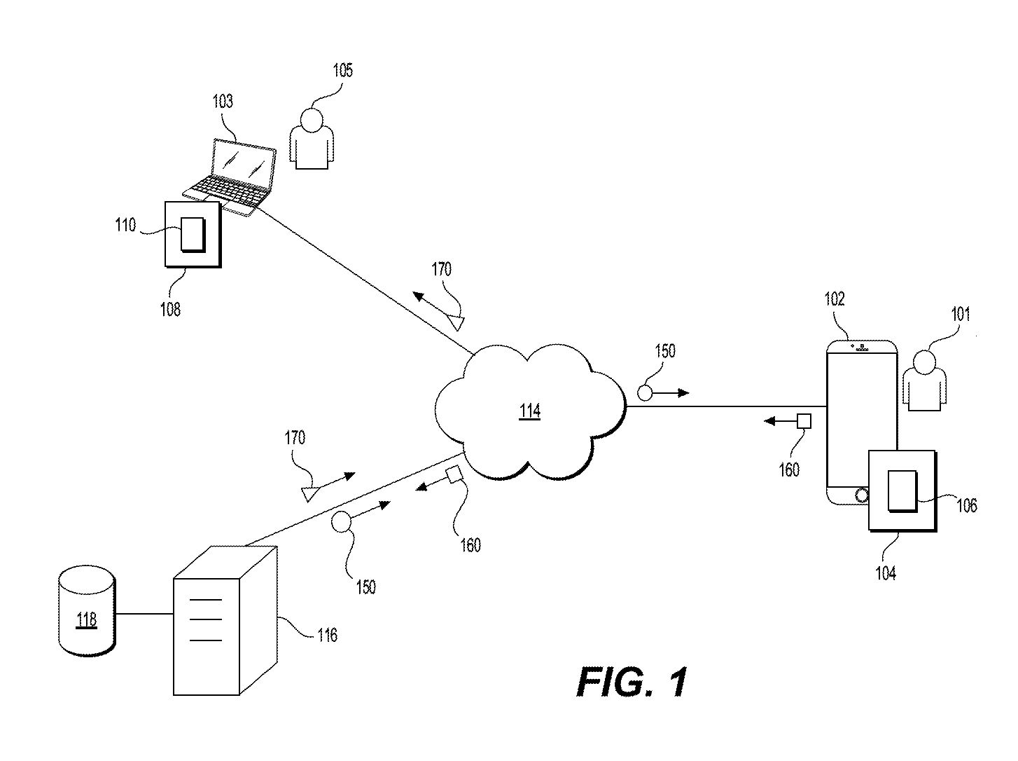

Referring to FIG. 1, there is shown a schematic diagram of a system 100, the system 100 being suitable for implementing non-limiting embodiments of the present technology. It is to be expressly understood that the system 100 is depicted as merely as an illustrative implementation of the present technology. Thus, the description thereof that follows is intended to be only a description of illustrative examples of the present technology. This description is not intended to define the scope or set forth the bounds of the present technology. In some cases, what are believed to be helpful examples of modifications to the system 100 may also be set forth below. This is done merely as an aid to understanding, and, again, not to define the scope or set forth the bounds of the present technology. These modifications are not an exhaustive list, and, as a person skilled in the art would understand, other modifications are likely possible. Further, where this has not been done (i.e. where no examples of modifications have been set forth), it should not be interpreted that no modifications are possible and/or that what is described is the sole manner of implementing that element of the present technology. As a person skilled in the art would understand, this is likely not the case. In addition it is to be understood that the system 100 may provide in certain instances simple implementations of the present technology, and that where such is the case they have been presented in this manner as an aid to understanding. As persons skilled in the art would understand, various implementations of the present technology may be of a greater complexity.

The system 100 comprises a first client device 102. The first client device 102 is typically associated with a user 101. It should be noted that the fact that the first client device 102 is associated with the user does not need to suggest or imply any mode of operation—such as a need to log in, a need to be registered or the like.

The implementation of the first client device 102 is not particularly limited, but as an example, the first client device 102 may be implemented as a personal computer (desktops, laptops, netbooks, etc.), a wireless client device (a cell phone, a smartphone, a tablet and the like), as well as network equipment (a router, a switch, or a gateway). The general implementation of the first client device 102 is known in the art and, as such, will not be described here at much length. Suffice it to say that the first client device 102 comprises a user input interface (such as a keyboard, a mouse, a touch pad, a touch screen and the like) for receiving user inputs; a user output interface (such as a screen, a touch screen, a printer and the like) for providing visual or audible outputs to the user; a network communication interface (such as a modem, a network card and the like) for two-way communication over a communication network 114; a storage (not depicted); and a processor coupled to the user input interface, the user output interface, the network communication interface and the storage, the processor being configured to execute various routines, including those described herein below. To that end the processor may store or have access to computer readable commands which commands, when executed, cause the processor to execute the various routines described herein.

The first client device 102 comprises hardware and/or software and/or firmware (or a combination thereof), as is known in the art, to execute a first email application 104. Generally speaking, the purpose of the first email application 104 is to enable the user 101 to: browse a list of emails (both unread and read), read specific email messages, open attachments, compose new email messages, reply to email messages, forward email messages, delete email messages, manage junk email messages, assign categories to email messages, organize email messages into folders, create and access an address book, manage email display based on user preferences and the like.

In some embodiments, the first email application 104 can be implemented as a webmail interface. In other embodiments, the first email application 104 may be executed on the first client device 102 in a form of an “app”. The latter is particularly applicable but not limited to those embodiments, where the first client device 102 is implemented as a smartphone or a tablet device. Irrespective of how the first email application 104 is implemented, the first email application 104 provides the user 101 with a first email interface 106. The first email interface 106 is configured, as known in the art, to allow the user 101 to interact with the first email application 104 in order to: browse a list of emails (both unread and read), read specific email messages, open attachments, compose new e-mail messages, reply to email messages, forward email messages, delete email messages, manage junk email messages, assign categories to email messages, organize email messages into folders, create and access an address book and the like. The list of example actions that the user 101 is able to execute with the first email interface 106 is not exhaustive and may include a number of additional or different examples.

The first client device 102 may be coupled to the above-mentioned communication network 114. In some non-limiting embodiments of the present technology, the communication network 114 can be implemented as the Internet. In other embodiments of the present technology, the communication network 114 can be implemented differently, such as any wide-area communication network, local-area communication network, a private communication network and the like.

It should be expressly understood that implementations for the first client device 102 are provided for illustration purposes only. As such, those skilled in the art will easily appreciate other specific implementational details for the first client device 102. As such, by no means, examples provided herein above are meant to limit the scope of the present technology.

The system 100 may comprise a second client device 103. The second client device 103 is typically associated with a user 105. It should be noted that the fact that the second client device 103 is associated with the user 105 does not need to suggest or imply any mode of operation—such as a need to log in, a need to be registered or the like.

In some embodiments of the present technology, the second client device 103 may be implemented similarly to the first client device 102 or, as in other embodiments, in a different manner. The second client device 103 may be configured to execute a second email application 108. The second email application 108 may provide a second email interface 110. The email interface 110 may be configured, as known in the art, to allow the user 105 to interact with the second email application 108 in order to: browse a list of emails (both unread and read), read specific email messages, open attachments, compose new email messages, reply to email messages, forward email messages, delete email messages, manage junk email messages, assign categories to email messages, organize email messages into folders, create and access an address book and the like. The list of example actions that the user 105 is able to execute with the second email interface 110 is not exhaustive and may include a number of additional or different examples. It should be noted that the second email application 108 may be distinct or identical to the first email application 104.

In other embodiments of the present technology, the system 100 may comprise a server 116. The server 116 may be implemented as a conventional computer server. In an example of an embodiment of the present technology, the server 116 may be implemented as a Dell™ PowerEdge™ Server running the Microsoft™ Windows Server™ operating system. Needless to say, the server 116 may be implemented in any other suitable hardware and/or software and/or firmware or a combination thereof. In the depicted non-limiting embodiment of present technology, the server 116 is a single server. In alternative non-limiting embodiments of the present technology, the functionality of the server 116 may be distributed and may be implemented via multiple servers.

The implementation of the server 116 is well known. However, briefly speaking, the server 116 may comprise a communication interface (not depicted) structured and configured to communicate with various entities (such as the first and second client devices 102 and 103, for example and other devices potentially coupled to the communication network 114) via the communication network 114. The server 116 may further comprises at least one computer processor (not depicted) operationally connected with the communication interface and structured and configured to execute various processes to be described herein.

In some embodiments, the server 116 may be operated by the same entity that has provided the afore-described first email application 104. In alternative embodiments, the server 116 may be operated by an entity different from the one who has provided the afore-mentioned first mail application 104. The server 116 may implement an email service such as Yandex.Mail, for example. It should be noted, the server 116 may implement any other email service.

The server 116 may be operatively connected to a database 118. In some embodiments of the present technology, the database 118 may be configured to store information related to emails which are destined to and/or originating from the user 101, the user 105 and other potential users of the email service implemented by the server 116. It should be noted that, in some implementations of the present technology, the server 116 and the database 118 may be implemented as part of a single entity. In other words, the functionalities of the server 116 and the database 118 may be executed by the server 116 as the single entity.

In additional embodiments, the database 118 may store account information associated with the user 101, the user 105 and the other potential users of the email service implemented by the server 116. For example, the database 118 may store a first account information associated with the user 101, a second account information associated with the user 105, and other potential account information respectively associated to each one of the other potential users of the email service.

In other embodiments, the server 116 may be configured to store within the database 118 information received and/or sent thereby. For example, the server 116 may store the information received and/or sent by the server 116 via a first signal 150, a second signal 160 and a third signal 190.

In some embodiments of the present technology, the user 101 may be desirous of viewing emails destined to and/or originated from the user 101. To that end, the user 101 may interact with the first client device 102 for executing the first email application 104. In other words, the first client device 102 may be configured to execute the first email application 104 for displaying the first email interface 106 to the user 101. In another embodiment, responsive to the execution of the first email application 104 by the first client device 102, the first client device 102 may further be configured to request the emails destined to and/or originated from the user 101 from the server 116 implementing the email service. To this end, the first client device 102 may send a request signal (not depicted) to the server 116. In a different embodiment, the first client device 102 may be configured to acquire from the server 116 the emails destined to and/or originated from the user 101 without sending the request signal. In other words, the email service may be a “push” or a “pull” email service, as it is known in the art.

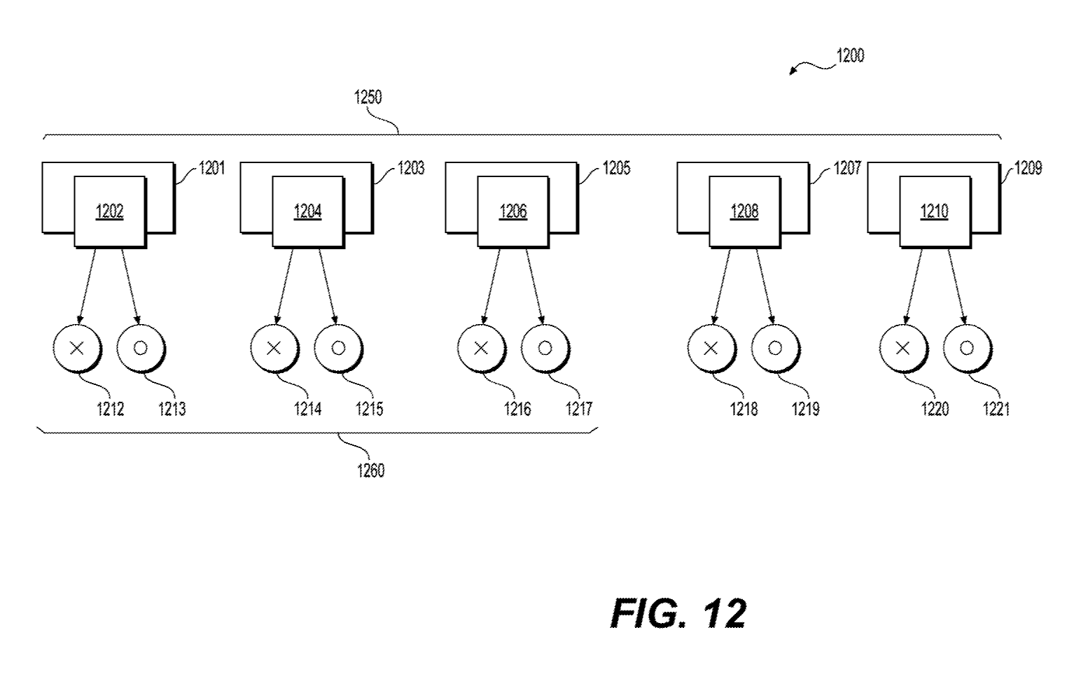

In other embodiments, the server 116 may be configured to generate a first signal 150. The first signal 150 may comprise inter alia information associated with the emails destined to and/or originated from the user 101. The server 116 may be configured to send the first signal 150, via the communication network 114, to the first client device 102. Let's assume that the first signal 150 comprises the information associated with a plurality of emails 1250 depicted in FIG. 12.

The plurality of emails 1250 may comprise a first email 1201, a second email 1203, a third email 1205, a fourth email 1207 and a fifth email 1209. Each email within the plurality of email 1250 may comprise a respective email-inherent data. For example, the first email 1201 may comprise a first email-inherent data 1202, the second email 1203 may comprise a second email-inherent data 1204, the third email 1205 may comprise a third email-inherent data 1206, the fourth email 1207 may comprise a fourth email-inherent data 1208 and the fifth email 1209 may comprise a fifth email-inherent data 1210. Each respective email-inherent data may be structured by the email service implemented by the server 116 according to an email-native protocol. For example, the email-native protocol of the email service implemented by the server 116 may be Simple Mail Transfer Protocol (SMTP). In additional embodiments, the email service implemented by the server 116 may be compatible with Extensible Messaging and Presence Protocol (XMPP).

In additional embodiments, each email-inherent data may comprise a respective header data and a respective body data. For example, the first email-inherent data 1202 may comprise a first header data 1212 and a first body data 1213, the second email-inherent data 1204 may comprise a second header data 1214 and a second body data 1215, the third email-inherent data 1206 may comprise a third header data 1216 and a third body data 1217, the fourth email-inherent data 1208 may comprise a fourth header data 1218 and a fourth body data 1219 and the fifth email-inherent data 1210 may comprise a fifth header data 1220 and a fifth body data 1221. It should be noted that each respective email-inherent data may comprise additional data and that each email-inherent data comprising the respective header data and body data are depicted in FIG. 12 for ease of understanding only.

In some embodiments, with reference to FIG. 1, the first client device 102 may receive the first signal 150. In other words, the first client device 102 may be configured to acquire the plurality of emails 1250, wherein each email within the plurality of emails 1250 comprises the respective email-inherent data which is structured by the email service according to the email-native protocol.

In additional embodiments, the user 101 may be desirous of viewing the emails within the plurality of emails 1250 in an email-style view thereof. In this case, the first email application 104 of the first client device 102 may display within the first email interface 106 each email within the plurality of emails 1250 in the aforementioned email-style view.

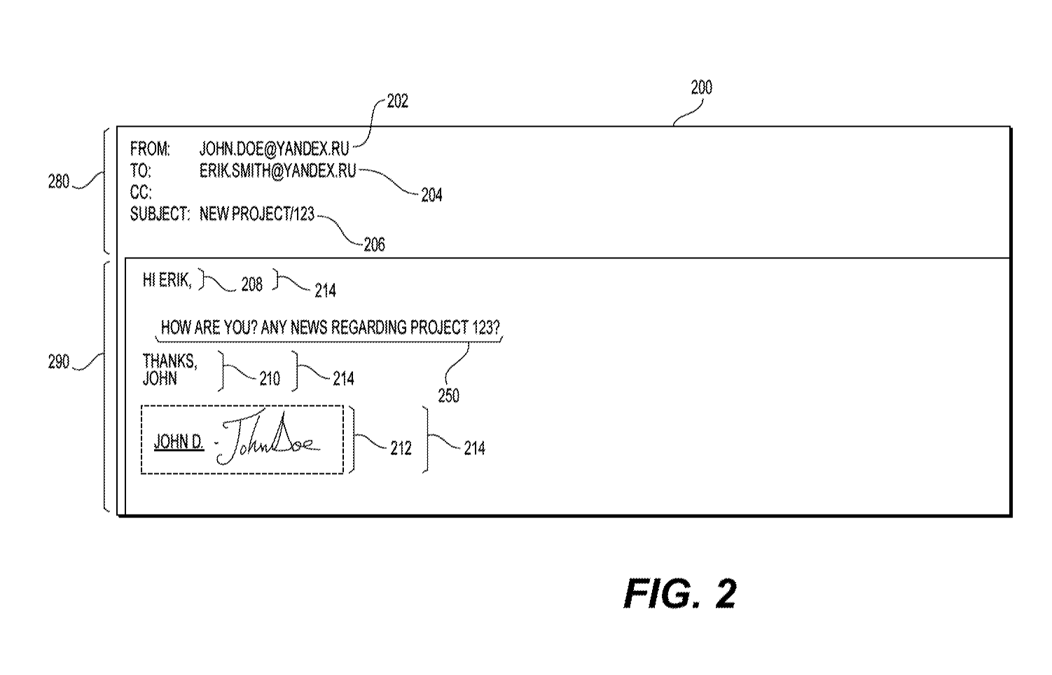

With reference to FIG. 2, there is depicted an email-style view 200 of the first email 1201. For example, the first email interface 106 may display the first email 1201 in the email-style view 200 of the first email 1201 to the user 101. The email-style view 200 of the first email 1201 may comprise a first header 280 associated with the first header data 1212 and a first body 290 associated with the first body data 1213 (see FIG. 12).

The first header 280 may comprise a first email address 202, a second email address 204 and a first subject 206. It should be noted that the first header 280 may comprise additional elements and that the first email address 202, the second email address 204 and the first subject 206 are depicted in FIG. 2 for ease of understanding only. Let's assume that the first email address 202 is associated with the user 105 of the second electronic device 103 and that the second email address 204 is associated with the user 101 of the first electronic device 102. In this case, the first email address 202 corresponds to a sender's email address of the first email 1201 and the second email address 204 corresponds to a recipient's email address of the first email 1201. Therefore, the first email 1201 is an inbound email since the first email 1201 is destined to the user 101 (i.e., the recipient's email address of the first email 1201 is associated with the user 101).

The first body 290 may comprise a first greeting 208, a first farewell 210, a first electronic signature 212 and a first text 250. It should be noted that the first body 290 may comprise additional elements and that the first greeting 208, the first farewell 210, the first electronic signature 212 and the first text 250 are depicted in FIG. 2 for ease of understanding only.

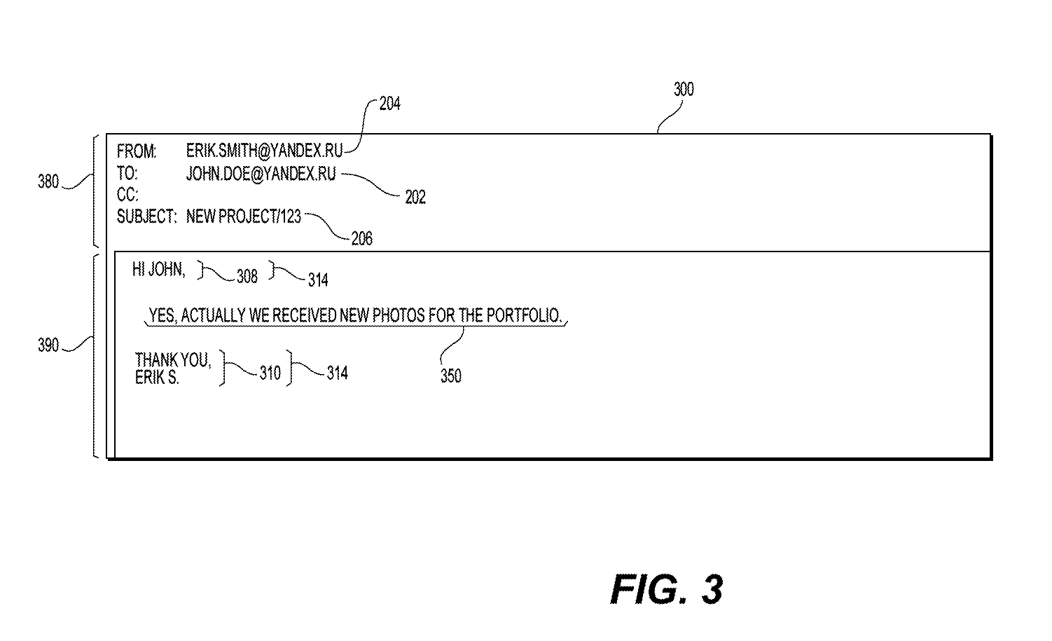

With reference to FIG. 3, there is depicted an email-style view 300 of the second email 1203. For example, the first email interface 106 may display the second email 1203 in the email-style view 300 of the second email 1201 to the user 101. The email-style view 300 of the second email 1201 may comprise a second header 380 associated with the second header data 1214 and a second body 390 associated with the second body data 1215 (see FIG. 12).

The second header 380 may comprise the first email address 202, the second email address 204 and the first subject 206. It should be noted that the first header 280 may comprise additional elements and that the first email address 202, the second email address 204 and the first subject 206 are depicted in FIG. 3 for ease of understanding only. In this case, the first email address 202 corresponds to the recipient's email address of the second email 1203 and the second email address 204 corresponds to the sender's email address of the second email 1203. Therefore, the second email 1203 is an outbound email since the second email 1203 is originated from the user 101 (i.e., the sender's email address of the first email 1201 is associated with the user 101).

The second body 390 may comprise a second greeting 308, a second farewell 310 and a second text 350. It should be noted that the second body 390 may comprise additional elements and that the second greeting 308, the second farewell 310 and the second text 350 are depicted in FIG. 3 for ease of understanding only.

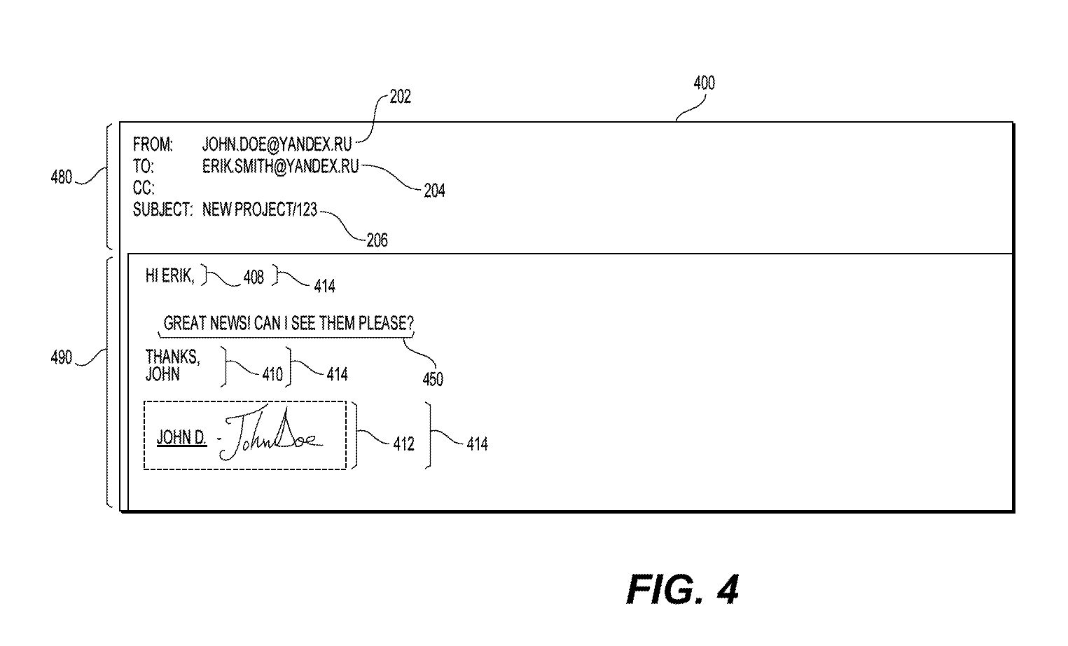

With reference to FIG. 4, there is depicted an email-style view 400 of the third email 1205. For example, the first email interface 106 may display the third email 1205 in the email-style view 400 of the third email 1205 to the user 101. The email-style view 400 of the third email 1205 may comprise a third header 480 associated with the third header data 1216 and a third body 490 associated with the third body data 1217 (see FIG. 12).

The third header 480 may comprise the first email address 202, the second email address 204 and the first subject 206. It should be noted that the third header 480 may comprise additional elements and that the first email address 202, the second email address 204 and the first subject 206 are depicted in FIG. 4 for ease of understanding only. In this case, the first email address 202 corresponds to the sender's email address of the third email 1205 and the second email address 204 corresponds to the recipient's email address of the third email 1205. Therefore, the third email 1205 is the inbound email since the third email 1205 is destined to the user 101 (i.e., the recipient's email address of the third email 1205 is associated with the user 101).

The third body 490 may comprise a third greeting 408, a third farewell 410, a third electronic signature 412 and a third text 450. It should be noted that the third body 490 may comprise additional elements and that the third greeting 408, the third farewell 410, the third electronic signature 412 and the third text 450 are depicted in FIG. 4 for ease of understanding only.

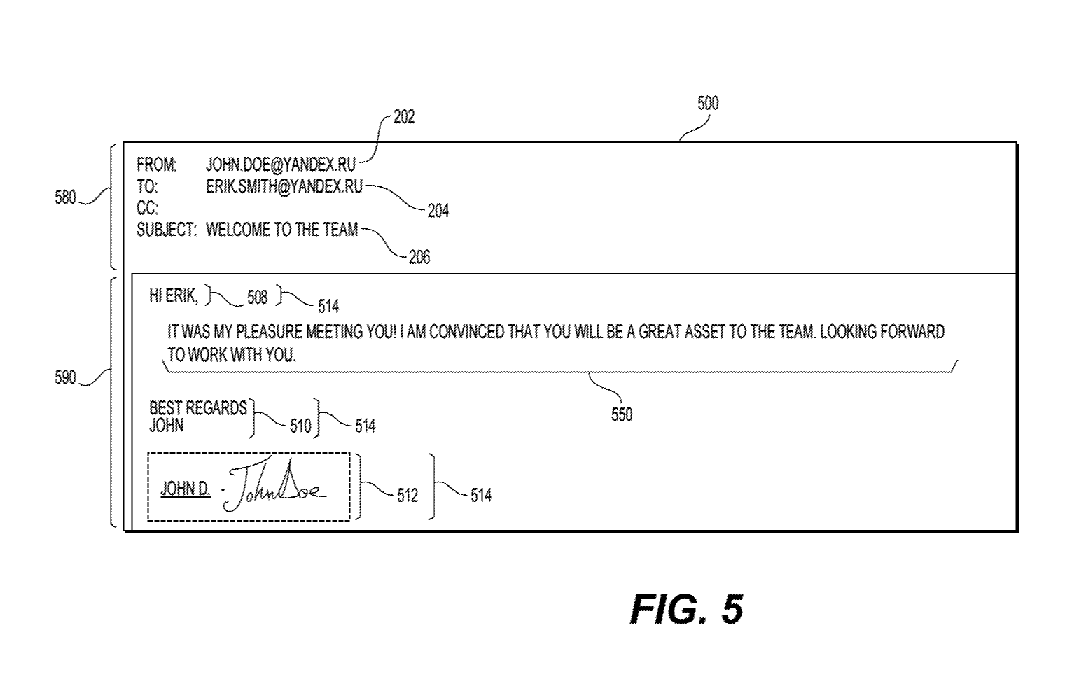

With reference to FIG. 5, there is depicted an email-style view 500 of the fourth email 1207. For example, the first email interface 106 may display the fourth email 1207 in the email-style view 500 of the fourth email 1207 to the user 101. The email-style view 500 of the fourth email 1207 may comprise a fourth header 580 associated with the fourth header data 1218 and a fourth body 590 associated with the fourth body data 1219 (see FIG. 12).

The fourth header 580 may comprise the first email address 202, the second email address 204 and a fourth subject 506. It should be noted that the fourth header 580 may comprise additional elements and that the first email address 202, the second email address 204 and the fourth subject 506 are depicted in FIG. 5 for ease of understanding only. In this case, the first email address 202 corresponds to the sender's email address of the fourth email 1207 and the second email address 204 corresponds to the recipient's email address of the fourth email 1207. Therefore, the fourth email 1207 is the inbound email since the fourth email 1207 is destined to the user 101 (i.e., the recipient's email address of the third email 1205 is associated with the user 101).

The fourth body 590 may comprise a fourth greeting 508, a fourth farewell 510, a fourth electronic signature 512 and a fourth text 550. It should be noted that the fourth body 590 may comprise additional elements and that the fourth greeting 508, the fourth farewell 510, the fourth electronic signature 512 and the fourth text 550 are depicted in FIG. 5 for ease of understanding only.

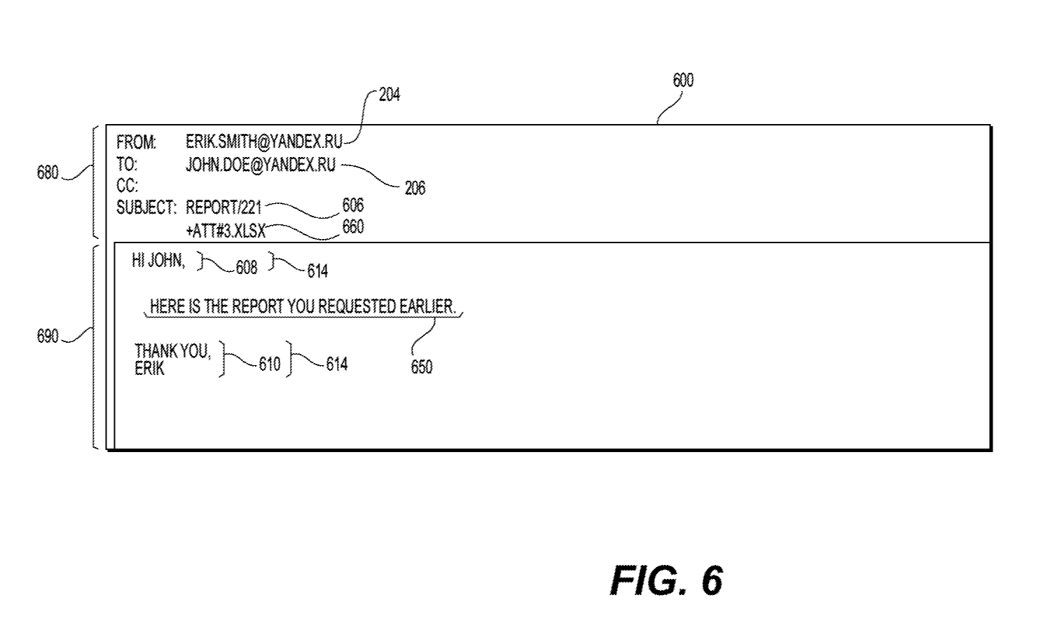

With reference to FIG. 6, there is depicted an email-style view 600 of the fifth email 1209. For example, the first email interface 106 may display the fifth email 1209 in the email-style view 600 of the fifth email 1209 to the user 101. The email-style view 600 of the fifth email 1209 may comprise a fifth header 680 associated with the fifth header data 1220 and a fifth body 690 associated with the fifth body data 1221 (see FIG. 12).

The fifth header 680 may comprise the first email address 202, the second email address 204, a fifth attachment indication 660 and a fifth subject 606. For example, the fifth attachment indication 660 may indicate to the user 101 that the fifth email 1209 further comprises a fifth attachment. It should be noted that the fifth header 680 may comprise additional elements and that the first email address 202, the second email address 204, the fifth attachment indication 660 and the fifth subject 606 are depicted in FIG. 6 for ease of understanding only. In this case, the first email address 202 corresponds to the recipient's email address of the fifth email 1209 and the second email address 204 corresponds to the sender's email address of the fifth email 1209. Therefore, the fifth email 1209 is the unbound email since the fifth email 1209 is originated from the user 101 (i.e., the sender's email address of the fifth email 1209 is associated with the user 101).

The fifth body 690 may comprise a fifth greeting 608, a fifth farewell 610 and a third text 650. It should be noted that the fifth body 690 may comprise additional elements and that the fifth greeting 608, the fifth farewell 610 and the fifth text 650 are depicted in FIG. 6 for ease of understanding only.

In some embodiments of the present technology, the user 101 may be desirous of viewing the emails within the plurality of emails 1250 in a messenger-style view thereof. In this case, the first email application 104 of the first client device 102 may display within the first email interface 106 each email within the plurality of emails 1250 in the aforementioned messenger-style view.

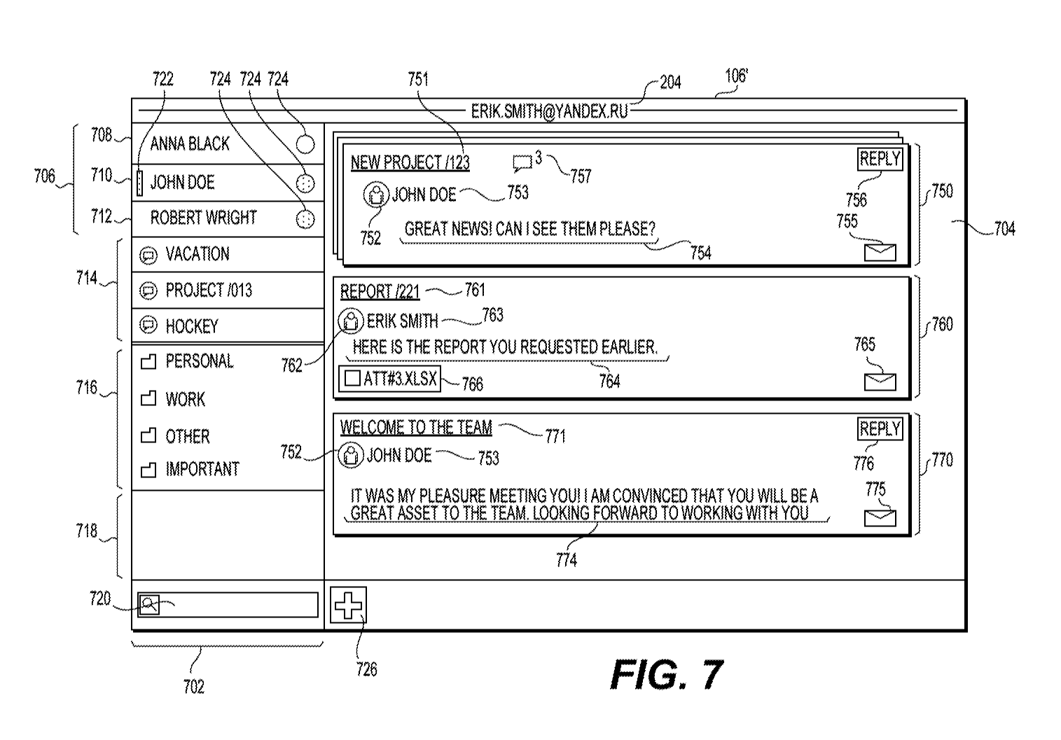

With reference to FIG. 7, there is depicted an embodiment of the first email interface 106′ which comprises a messenger-style view 704 of the plurality of emails 1250. For example, the first email interface 106′ may display the plurality of emails 1250 in the messenger-style view 704 of the plurality of emails 1250 to the user 101.

The first email interface 106′ may indicate the second email address 204 associated with the user 101 as depicted in FIG. 7. The first email interface 106′ may comprise a sidebar 702 and the messenger-style view 704 of the plurality of emails 1250. The sidebar 702 may comprise a contact list 706, a conversation list 714, a folder list 716, a function list 718 and a search bar 720. The sidebar 702 may comprise additional lists and/or bars for executing additional email functionalities of the first email application 104 and/or to provide a more convivial user experience to the user 101 while managing the emails destined to and/or originated therefrom.

In this case, the contact list 706 may comprise a first contact 708, a second contact 710 and a third contact 712. As depicted in FIG. 7, the second contact 710 may be associated with “John Doe”, who in this case, may be the user 105. Upon selecting the second contact 710 by the user 101 within the first email interface 106′, a selection indicator 722 may appear next to the second contact 710. In response, the first email interface 106′ of the first email application 104 executed by the first client device 102 may display the messenger-style view 704 of the plurality of emails 1250 since each email within the plurality of emails 1250 has been sent to and/or from the first email address 202 associated with the second contact 710 (i.e., the user 105). For example, if the user 101 selects the first contact 708, the first email interface 106′ may display another messenger-style view of emails sent to and/or from another email address associated with the first contact 708. The contact list 706 may comprise a plurality of availability indicators 724 wherein each availability indicator within the plurality of availability indicators 724 is associated with the respective contact within the contact list 706. Each availability indicator within the plurality of availability indicators 724 may indicate whether or not the respective contact within the contact list 706 is currently available and/or is online. Further, the user 101 may add a new contact to the contact list 706 by selecting/interacting with a new contact button 726.

The conversation list 714 may comprise a list of conversations that are associated to more than one contact within the contact list 706. For example, a conversation “Hockey” may be associated with the second contact 710 and the third contact 712. In other words, upon the user 101 selecting the conversation “Hockey” within the conversation list 714, the first email interface 106′ may display to the user 101 emails sent to and/or from both email addresses respectively associated with the second contact 710 and the third contact 712.

The folder list 716 may display a plurality of folders for an additional email classification functionality. For example, the user 101 may be desirous to classify at least some emails destined to and/or originated from the user 101 by adding the at least some emails to a folder within the plurality of folders displayed within the folder list 716. The function list 718 may comprise a list of functions furnished by the first email application 104. The search bar 720 may allow the user 101 to search emails, files, attachments, folders, contacts and the like within the first email application 104.

The messenger-style view 704 of the plurality of emails 1250 may comprise a grouped message element 750, a first individual message element 760 and a second individual message element 770.

In some embodiments of the present technology, the first client device 102 may be configured to generate the grouped message element 750 wherein the grouped message element 750 is associated with a group of emails 1260 within the plurality of emails 1250. The group of emails 1260 may comprise inbound emails and outbound emails. The first client device 102 may generate the grouped message element 750 by determining that each email within the group of emails 1260 is associated with the grouped message element 750 based on a grouping parameter within the respective email-inherent data of each email within the group of emails 1260.

In other embodiments of the present technology, the first client device 102 may be configured to generate the first individual message element 760 and the second individual message element 770. The first individual message element 760 may be associated with a first individual email within the plurality of emails 1250. The second individual message element 770 may be associated with a second individual email within the plurality of emails 1250. In some embodiments, the first client device 102 may generate the first individual message element 760 by determining that the first individual email is not associated with the grouped message element 750 based on the grouping parameter within the email-inherent data of the first individual email. The first client device 102 may generate the second individual message element 770 by determining that the second individual email is not associated with the grouped message element 750 based on the grouping parameter within the email-inherent data of the second individual email. In some implementations of the present technology, the respective email-inherent data may be structured according to the Simple Mail Transfer Protocol (SMTP). In other implementations, the respective email-inherent data may be structured according to the Extensible Messaging and Presence Protocol (XMPP).

In some embodiments, the grouping parameter may correspond to a subject of a given email. The first client device 102 may be configured to parse the first header data 1212, the second header data 1214, the third header data 1216, the fourth header data 1218 and the fifth header data 1220 for determining the respective subject of each email within the plurality of emails 1250. For example, the first client device 102 may determine that the first email 1201, the second email 1203 and the third email 1205 are associated with the first subject 206 “New Project/123” (see FIGS. 2, 3 and 4). The first client device 102 may determine that the fourth email 1207 is associated with the fourth subject 506 “Welcome to the team” (see FIG. 5). The first client device 102 may determine that the fifth email 1209 is associated with the fifth subject 606 “Report/221” (see FIG. 6).

The first client device 102 may associate the first email 1201, the second email 1203 and the third email 1205 within the group of emails 1260 with the grouped message element 750 since the first email 1201, the second email 1203 and the third email 1205 are associated with the first subject 206. The first client device 102 may associate the fifth email 1207 with the second individual message element 770 since the fifth email 1207 is associated with the fifth subject 506, which is different from the first subject 206. In this case, the fifth email 1207 may correspond to the second individual email. The first client device 102 may associate the sixth email 1209 with the first individual message element 760 since the sixth email 1209 is associated with the sixth subject 606, which is different from the first subject 206 and the fifth subject 506. In this case, the sixth email 1209 may correspond to the first individual email.

In other embodiments, the grouped message element 750 may comprise a grouped subject 751. In this case, the grouped subject 751 may correspond to the first subject 206. The grouped message element 750 may comprise a thread indicator 757 to inform the user 101 about how many emails are associated with the grouped message element 750. In this case, the thread indicator 757 may display “3” to inform the user 101 that three emails are associated with the grouped message element 750.

In some embodiments, the grouped message element 750 may display to the user 101 at least some information associated with a most recent email amongst the group of emails 1260. Let's assume that the most recent email amongst the group of emails 1260 is the third email 1205. In this case, the grouped message element 750 may display a first contact icon 752 and a first contact name 753 associated with the sender's email address of the third email 1205. As previously alluded to, the sender's email address of the third email 1205 may correspond to the first email address 202 which is associated with the second contact 710. Therefore, the first contact icon 752 and the first contact name 753 may be associated with the user 105 (i.e., the second contact 710).

The at least some information associated with the most recent email amongst the group of emails 1260 may comprise a portion of the most recent email 754 amongst the group of emails 1260. In some embodiments of the present technology, the first client device 102 may extract the portion of the most recent email 754 within the group of emails 1260 from the email-inherent data of the most recent email within the group of emails 1260. The first client device 102 may extract the portion of the most recent email 754 within the group of emails 1260 from the third body data 1217 of the third email 1205 since the third email 1205 is the most recent email amongst the group of emails 1260. The first client device 102 may extract the portion of the most recent email 754 within the group of emails 1260 from the third body data 1217 of the third email 1205 by executing a regular expression analysis, a parsing routine, via masks and the like. For example, the first client device 102 may determine that the third greeting 408, the third farewell 410 and the third electronic signature 412 are a redundant portion 414 of the third body 490 (see FIG. 4). As a result, the first client device 102 may determine that the third text 450 corresponds to the portion of the most recent email 754 to be displayed within the grouped message element 750. It should be noted that determining the redundant portion 414 and the portion of the most recent email 754 may allow the first client device 102 to provide a convivial display of the third email 1217 to the user 101.

The grouped message element 750 may further comprise a third reply button 756 and a third email-style view button 755. The third reply button 756 may enable the user 101 to reply to the third email 1205 following an interaction therewith by the user 101. The third email-style view button 755 may allow the user 101 to view the third email 1205 in the email-style view 400 of the third email 1205. Upon the user 101 interacting with the third email-style view button 755, the first client device 102 may be configured to trigger the display of the email-style view 400 of the third email 1205 within the first email interface 106 of the first email application 104 (see FIG. 4).

The first individual message element 760 may comprise a first individual subject 761. In this case, the first individual subject 761 may correspond to the fifth subject 606 (see FIG. 6). In some embodiments, the first individual message element 760 may display to the user 101 at least some information associated with the first individual email (i.e. the fifth email 1209). In this case, the first individual message element 760 may display a second contact icon 762 and a second contact name 763 associated with the sender's email address of the fifth email 1209. As previously alluded to, the sender's email address of the fifth email 1209 may correspond to the second email address 204 which is associated with the user 101. Therefore, the second contact icon 762 and the second contact name 763 may be associated with the user 101.

The at least some information associated with the first individual email may comprise a portion of the first individual email 764. In some embodiments of the present technology, the first client device 102 may extract the portion of the first individual email 764 from the email-inherent data of the first individual email (i.e. the fifth email 1209). The first client device 102 may extract the portion of the first individual email 764 from the fifth body data 1221 of the fifth email 1209 since the fifth email 1209 is the first individual email. The first client device 102 may extract the portion of the first individual email 764 from the fifth body data 1221 of the fifth email 1209 by executing the regular expression analysis, the parsing routine, via the masks and the like. For example, the first client device 102 may determine that the fifth greeting 608 and the fifth farewell 610 are a redundant portion 614 of the fifth body 690 (see FIG. 6). As a result, the first client device 102 may determine that the fifth text 650 corresponds to the portion of the first individual email 764 to be displayed within the first individual message element 760.

The first individual message element 760 may further comprise a fifth email-style view button 765. The fifth email-style view button 765 may allow the user 101 to view the fifth email 1209 in the email-style view 600 of the fifth email 1209. Upon the user 101 interacting with the fifth email-style view button 765, the first client device 102 may be configured to trigger the display of the email-style view 600 of the fifth email 1209 within the first email interface 106 of the first email application 104. The first individual message element 760 may comprise an attachment button 766 to allow the user 101 to open the fifth attachment of the fifth email 1209.

The second individual message element 770 may comprise a second individual subject 771. In this case, the second individual subject 771 may correspond to the fourth subject 506 (see FIG. 5). In some embodiments, the second individual message element 770 may display to the user 101 at least some information associated with the second individual email (i.e. the fourth email 1207). In this case, the second individual message element 770 may display the first contact icon 752 and the first contact name 753 associated with the sender's email address of the fourth email 1207. As previously alluded to, the sender's email address of the fourth email 1209 may correspond to the first email address 202 which is associated with the second contact 710. Therefore, the first contact icon 752 and the first contact name 753 may be associated with the user 105.

The at least some information associated with the second individual email may comprise a portion of the second individual email 774. In some embodiments of the present technology, the first client device 102 may extract the portion of the second individual email 774 from the email-inherent data 1208 of the fourth email 1207 (i.e., the second individual email). The first client device 102 may extract the portion of the second individual email 774 from the fourth body data 1219 of the fourth email 1207 since the fourth email 1207 is the second individual email. The first client device 102 may extract the portion of the second individual email 774 from the fourth body data 1219 of the fourth email 1207 by executing the regular expression analysis, the parsing routine, via the masks and the like. For example, the first client device 102 may determine that the fourth greeting 508, the fourth farewell 510 and the fourth electronic signature are a redundant portion 514 of the fourth body 590 (see FIG. 5). As a result, the first client device 102 may determine that the fourth text 550 corresponds to the portion of the second individual email 774 to be displayed within the second individual message element 770.

The second individual message element 770 may further comprise a fourth email-style view button 775. The fourth email-style view button 775 may allow the user 101 to view the fourth email 1207 in the email-style view 500 of the fourth email 1207. Upon the user 101 interacting with the fourth email-style view button 775, the first client device 102 may be configured to trigger the display of the email-style view 500 of the fourth email 1207 within the first email interface 106 of the first email application 104. The second individual message element 770 may comprise a fourth reply button 776. The fourth reply button 776 may enable the user 101 to reply to the fourth email 1207 following an interaction therewith by the user 101.

In some embodiments of the present technology, the user 101 may determine that the group of emails 1260 within the plurality of emails 1250 is associated with the grouped message element 750. The user 101 may determine that another email within the plurality of email 1250 is associated with the grouped message element 750. For example, the user 101 may determine that the second individual email (i.e., the fourth email 1207) is associated with the grouped message element 750 even though the fourth subject 506 is different from the first subject 206. In other words, the user 101 may determine that the second individual email (i.e., the fourth email 1207) is associated with the grouped message element 750 even though the grouping parameter of the first email 1201, the second email 1203, the third email 1205 is different from the grouping parameter of the fourth email 1207. In this case, the user 101 may “drag” the second individual message element 770 associated with the second individual message and “drop” it over the grouped message element 750. As a result, the fourth email 1207 may be associated by the user 101 with the grouped message element 750.

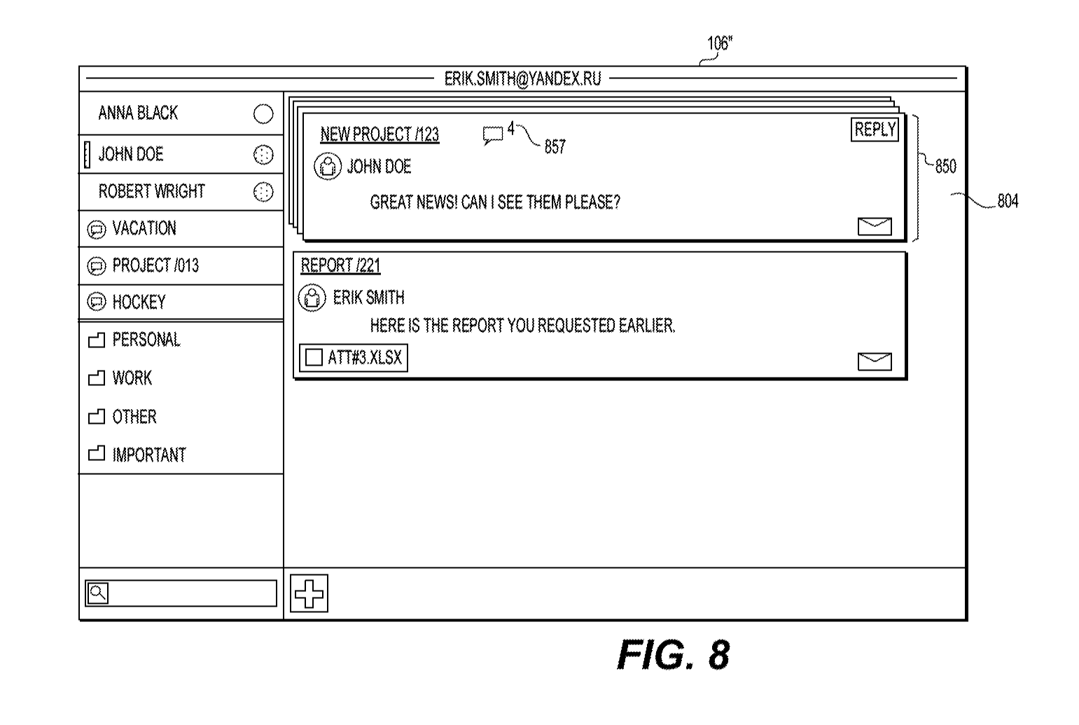

With reference to FIG. 8, there is depicted another embodiment of the first email interface 106″ of the first email application 104 executed by the first client device 102. The first email interface 106″ may display a messenger-style view 804 of the plurality of emails 1250 following the “drag and drop” of the second individual message element 770 by the user 101 over the grouped message element 750. As a result, an updated grouped message element 804 may be displayed to the user 101 and the second individual message element 770 may be omitted in the display of the messenger-style view 804 of the plurality of emails 1250. An updated thread indicator 857 may be displayed for informing the user 101 that the updated grouped message element 804 is now associated with four emails within the plurality of emails 1250. In this case, the fourth email 1207 may have been sent prior to the most recent email amongst the group of emails 1260.

In some embodiments of the present technology, the first client device 102 may be configured to generate the grouped message element 750 which is expandable for displaying a portion of each email within the group of emails 1260 associated with the grouped message element 750. As a result, the user 101 may interact with the grouped message element 750 by, for example, double clicking the grouped message element 750 for triggering the expansion thereof. In other implementations of the present technology, the user 101 may interact in alternative manners with the grouped message element 750 for triggering the expansion thereof.

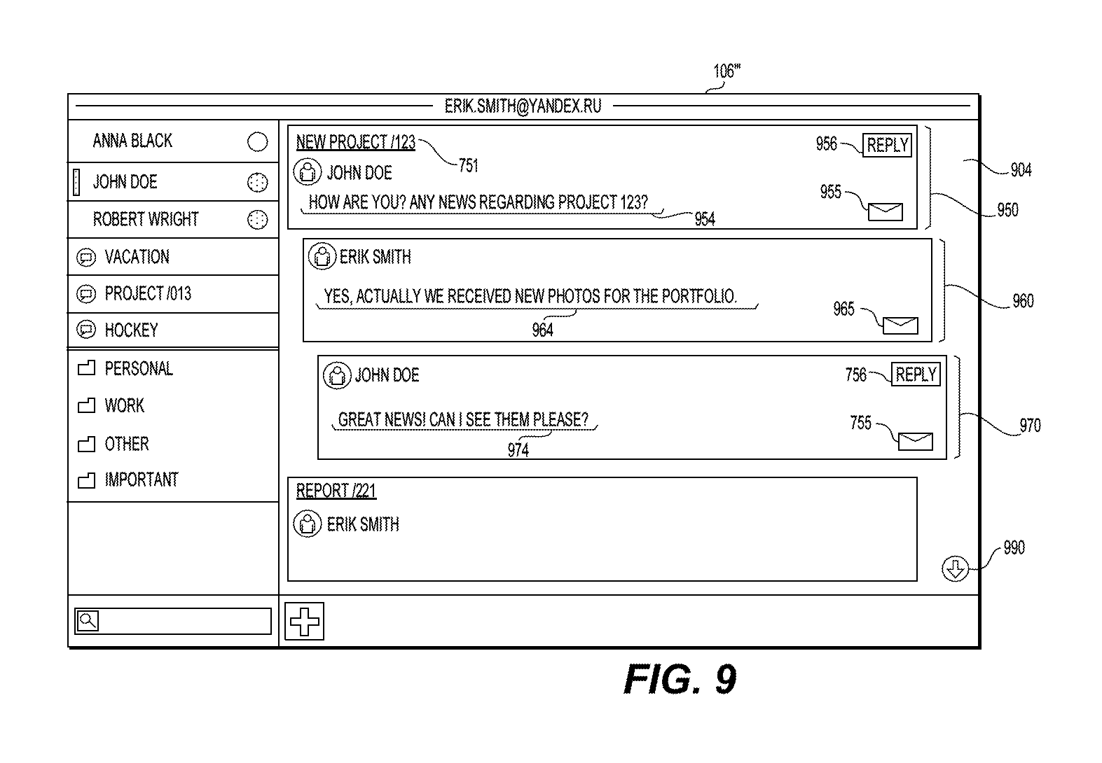

With reference to FIG. 9, there is depicted another embodiment of the first email interface 106′″ of the first email application 104 executed by the first client device 102. The first email interface 106′″ may display a messenger-style view 904 of the plurality of emails 1250 following the expansion of the grouped message element 750. In some embodiments, the first email interface 106′″ may display a first thread element 950, a second thread element 960 and a third thread element 970. The first thread element 950 may be associated with the first email 1201, the second thread element 960 may be associated with the second email 1203 and the third thread element 970 may be associated with the third email 1205. As depicted in FIG. 9, the first thread element 950, the second thread element 960 and the third thread element 970 may be visually distinguishable from one another to the user 101.

In some embodiments of the present technology, the first thread element 950 may comprise a portion 954 of the first email 1201, the second thread element 960 may comprise a portion 964 of the second email 1203 and the third thread element 970 may comprise a portion 974 the third email 1205. The first client device 102 may determine the portion 954 of the first email 1201, the portion 964 of the second email 1203 and the portion 974 the third email 1205 in a similar manner to how the first client device 102 determined the portion of the most recent email 754.

For example, the first client device 102 may determine that the first greeting 208, the first farewell 210 and the first electronic signature 212 are a redundant portion 214 of the first body 290 associated with the first email 1201. As a result, the first client device 102 may determine that the first text 250 corresponds to the portion 954 of the first email 1201 to be displayed within the first thread element 950.

For example, the first client device 102 may determine that the second greeting 308 and the second farewell 310 are a redundant portion 314 of the second body 390 associated with the second email 1201. As a result, the first client device 102 may determine that the second text 350 corresponds to the portion 964 of the second email 1201 to be displayed within the second thread element 950.

The first thread element 950 may comprise a first reply button 956 for allowing the user 101 to reply to the first email 1201. The first thread element 950 may comprise a first email-style view button 955 for allowing the user 101 to display the first email 1201 in the email-style view 200 of the first email 1201. The second thread element 960 may comprise a second email-style view button 965 for allowing the user 101 to display the second email 1203 in the email-style view 300 of the second email 1203.

The messenger-style view 904 of the plurality of emails 1250 may comprise a scrolling element 990 for allowing the user 101 to scroll the messenger-style view 904 of the plurality of emails 1250. In other words, the expansion of the grouped message element 750 may “push down” the first individual message element 760 and the second individual message element 780 within the messenger-style view 904 of the plurality of emails 1250. In other embodiment, the user 101 may select the first subject 751 depicted in FIG. 9 to “collapse” the first thread element 950, the second thread element 960 and the third thread element 970 for displaying the grouped message element 750 instead of the first thread element 950, the second thread element 960 and the third thread element 970.

In some embodiments of the present technology, the user 101 may be desirous to reply to the most recent email within the group of emails 1260 (i.e., the third email 1205). As previously alluded to, with reference to FIG. 7, the user 101 may interact with the third reply button 756 to compose and send a sixth email (not depicted) to the user 105. As a result, the first client device 102 may generate the second signal 160 comprising a sixth email-inherent data (not depicted) of the sixth email. The sixth email-inherent data may comprise a sixth header data (not depicted) and a sixth body data (not depicted). The second signal 160 may be sent by the first client device 102 to the server 116 via the communication network 114. Upon receiving the second signal 160, the server 116 may store the sixth email-inherent data of the sixth email within the database 118. The server 116 may generate and sent a third signal 170 to the second electronic device 103. The third signal 170 may comprise the sixth email-inherent data of the sixth email that is destined to the user 105.

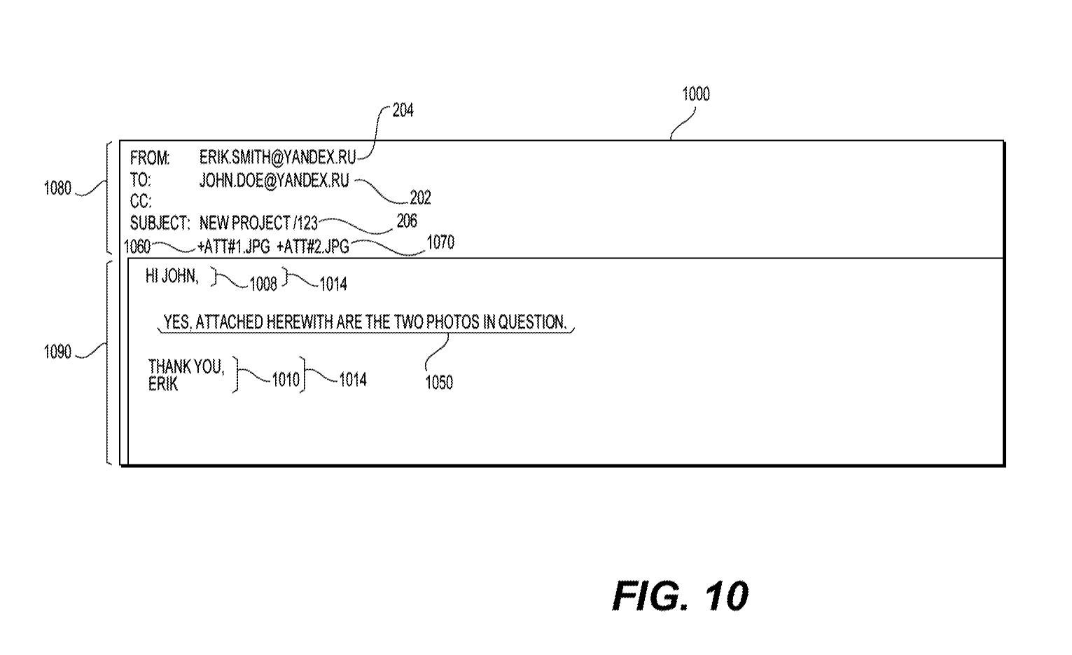

With reference to FIG. 10 there is depicted an email-style view 1000 of the sixth email. For example, the first email interface 106 may display the sixth email in the email-style view 1000 of the sixth email to the user 101. The email-style view 1000 of the sixth email may comprise a sixth header 1080 associated with the sixth header data and the sixth body associated with the sixth body data.

The sixth header 1080 may comprise the first email address 202, the second email address 204 and the first subject 206. The sixth email-inherent data may also comprise two attachments. As a result, the sixth header 1080 may comprise two attachments indicators 1060 and 1070, each for a respective attachment amongst the two attachments. It should be noted that the sixth header 1080 may comprise additional elements and that the first email address 202, the second email address 204 and the first subject 206 are depicted in FIG. 10 for ease of understanding only. In this case, the second email address 204 corresponds to the sender's email address of the sixth email and the first email address 202 corresponds to the recipient's email address of the sixth email. Therefore, the sixth email 1207 is the outbound email since the sixth email is originated from the user 101 (i.e., the sender's email address of the sixth email is associated with the user 101).

The sixth body 1090 may comprise a sixth greeting 1008, a sixth farewell 1010 and a sixth text 1050. It should be noted that the sixth body 1090 may comprise additional elements and that the sixth greeting 1008, the sixth farewell 1010 and the fourth text 550 are depicted in FIG. 10 for ease of understanding only.

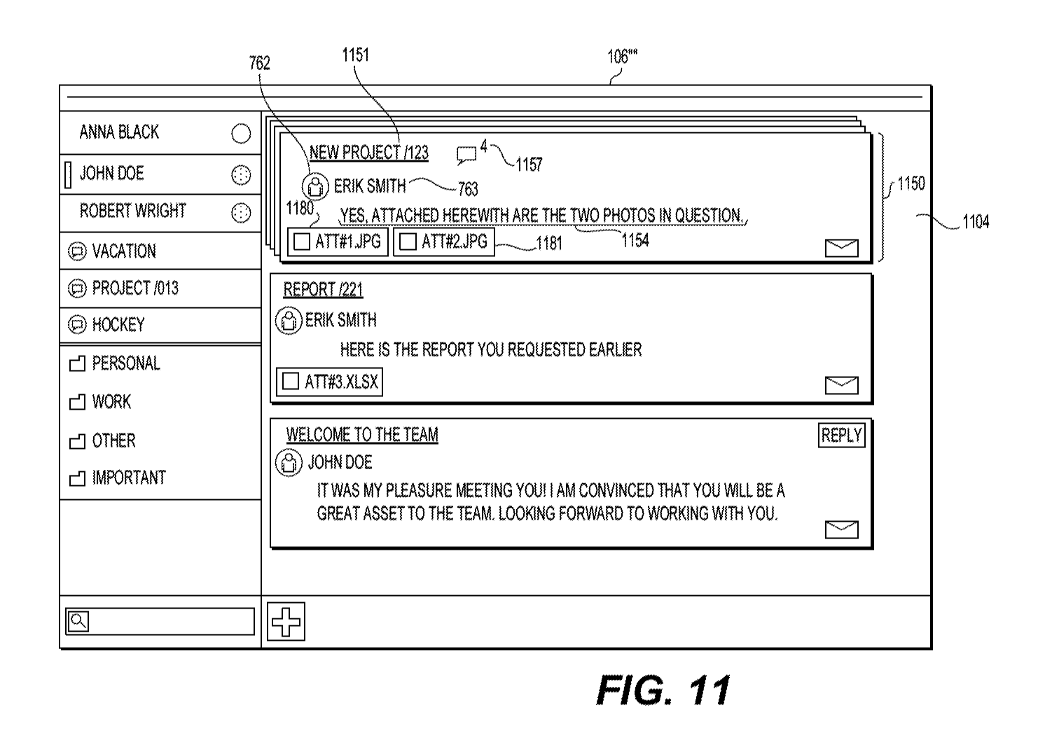

In additional embodiments, the first client device 102 may associate the sixth email with the grouped message element 750 since the sixth email is associated with the first subject 206. With reference to FIG. 11, there is depicted another embodiment of the first user interface 106″″ of the first email application 104 executed by the first client device 102. The first user interface 106″″ may display a new grouped message element 1150 within a messenger-style view 1104 of the plurality of emails 1250 and the sixth email.

In other embodiments, the new grouped message element 1150 may comprise a grouped subject 1151. In this case, the grouped subject 1151 may correspond to the first subject 206. The grouped message element 1150 may comprise a thread indicator 1157 to inform the user 101 about how many emails are associated with the grouped message element 1150. In this case, the thread indicator 1157 may display “4” to inform the user 101 that four emails (the first email 1201, the second email 1203, the third email 1205 and the sixth email) are associated with the grouped message element 1150.

In some embodiments, the grouped message element 1150 may display to the user 101 at least some information associated with the most recent email amongst the group of emails 1260 and the sixth email. In this case, the most recent email amongst the group of emails 1260 and the sixth email is the sixth email. Therefore, the grouped message element 1150 may display the second contact icon 762 and the second contact name 763 associated with the sender's email address of the sixth email. As previously alluded to, the sender's email address of the sixth email may correspond to the second email address 204 which is associated with the user 101. Therefore, the second contact icon 762 and the second contact name 763 may be associated with the user 101.

The at least some information associated with the most recent email amongst the group of emails 1260 and the sixth email may comprise a portion of the most recent email 1154. In some embodiments of the present technology, the first client device 102 may extract the portion of the most recent email 1154 from the email-inherent data of the sixth email being the most recent email amongst the group of emails 1260 and the sixth email. The first client device 102 may extract the portion of the most recent email 1154 from the sixth body data of the sixth email. The first client device 102 may extract the portion of the most recent email 1154 the sixth body data of the sixth email by executing the regular expression analysis, the parsing routine, via the masks and the like. For example, the first client device 102 may determine that the sixth greeting 1008, the sixth farewell 1010 are a redundant portion 1014 of the sixth body 1090 (see FIG. 10). As a result, the first client device 102 may determine that the sixth text 1050 corresponds to the portion of the most recent email 1154 to be displayed within the new grouped message element 1150. It should be noted that determining the redundant portion 1114 and the portion of the most recent email 1154 may allow the first client device 102 to provide a convivial display of the sixth email to the user 101.

The new grouped message element 1150 may comprise attachment buttons 1180 and 1181 to allow the user 101 to open the respective attachment amongst the two attachments of the sixth email. The new grouped message element 1150 may further comprise a sixth email-style view button 1155. The sixth email-style view button 1155 may allow the user 101 to view the sixth email in the email-style view 1000 of the sixth email (see FIG. 10). Upon the user 101 interacting with the sixth email-style view button 1155, the first client device 102 may be configured to trigger the display of the email-style view 1000 of the sixth email 1205 within the first email interface 106 of the first email application 104 (see FIG. 4).

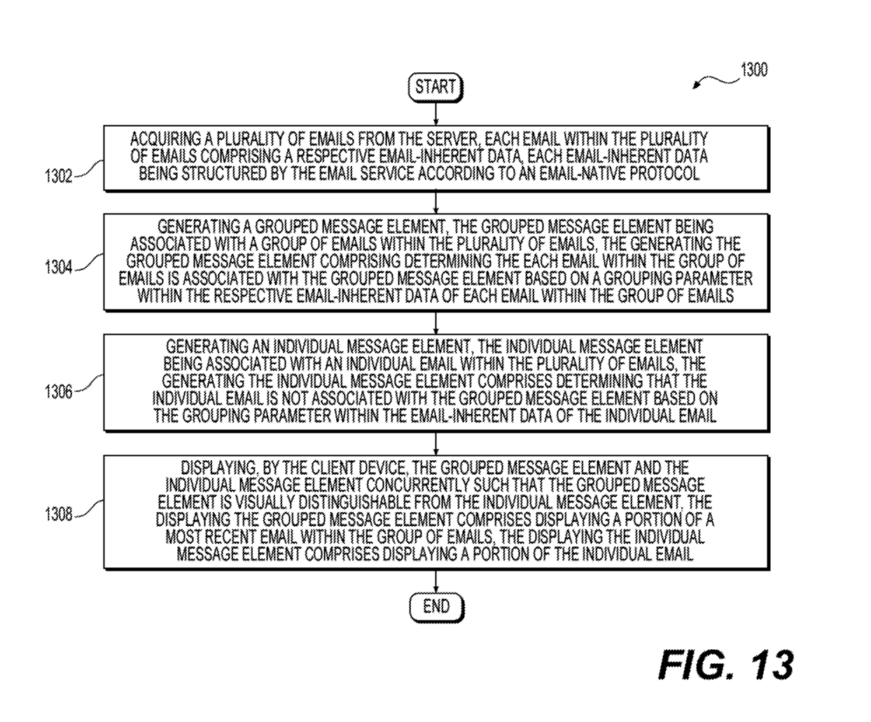

In some embodiments of the present technology, the first client device 102 may execute a method 1300 depicted in FIG. 13 of processing emails. The method 1300 will be further described below.

Step 1302: Acquiring a Plurality of Emails

The method 1300 begins at step 1302 with the first client device 102 acquiring the plurality of emails 1250 (see FIG. 12) from the server 116, wherein each email within the plurality of emails 1250 comprises the respective email-inherent data and each email-inherent data is structured by the email service according to the email-native protocol.

In some embodiments, the first client device 102 may acquire the respective email-inherent data of each email within the plurality of emails 1250 via the first signal 150 from the server 116. For example, with reference to FIG. 12, the first email 1201 may comprise the first email-inherent data 1202, the second email 1203 may comprise the second email-inherent data 1204, the third email 1205 may comprise the third email-inherent data 1206, the fourth email 1207 may comprise the fourth email-inherent data 1208 and the fifth email 1209 may comprise the fifth email-inherent data 1210.

Each respective email-inherent data may be structured by the email service implemented by the server 116 according to the email-native protocol. For example, the email-native protocol of the email service implemented by the server 116 may be SMTP. In additional embodiments, the email service implemented by the server 116 may be compatible with XMPP.

Step 1304: Generating a Grouped Message Element

The method 1300 continues to step 1304 with the first client device 102 generating the grouped message element 750 (see FIG. 7), wherein the grouped message element 750 is associated with the group of emails 1260 within the plurality of emails 1250. The generating the grouped message element 750 by the first client device 102 may comprise determining that each email within the group of emails 1260 is associated with the grouped message element 750 based on the grouping parameter within the respective email-inherent data of each email within the group of emails 1260.

In some embodiments, the grouping parameter of each email within the group of emails 1260 may be the respective subject of each email within the group of emails 1260.

The grouped message element 750 may be expandable for displaying the portion of each email within the group of emails 1260, as depicted in FIG. 9, associated with the grouped message element 750. The plurality of emails 1250 may comprises the inbound emails and the outbound emails. The group of emails 1260 may comprise at lease one inbound email and/or at least one outbound email. The displaying the portion of each email within the group of emails 1260 may comprise displaying, by the client device 102, the portion of the inbound and the outbound email within the group of emails 1260 such that the portion of the inbound email is visually distinguishable from the portion of the outbound email

Step 1306: Generating an Individual Message Element

The method 1300 continues to step 1306 with the first client device 102 generating an individual message element, wherein the individual message element is associated with an individual email within the plurality of emails 1250. The generating the individual message element by the first client device may comprise determining that the individual email is not associated with the grouped message element 750 based on the grouping parameter within the email-inherent data of the individual email.

In some embodiments, the first client device 102 may generate the first individual message element 760. The first client device 102 may generate the second individual message element 770. The first individual message element 760 may be associated with the first individual email being the fifth email 1209. The second individual message element 770 may be associated with the second individual email being the fourth email 1207.

In other embodiments, the determining that the group of emails 1260 within the plurality of emails 1250 is associated with the grouped message element may be executed by the user 101.

In additional embodiments, the determining that the individual email within the plurality of emails 1250 is associated with the individual message element may be executed by the user 101. For example, the user 101 may indicate that a given email within the group of emails 1260 is not associated with the grouped message element 750. In this case, the first client device 102 may display in the messenger-style view 704 a given individual message element associated with the given email.

Step 1308: Displaying the Grouped Message Element and the Individual Message Element

The method 1300 ends at step 1308 with the first client device 102 displaying the grouped message element 750 and the individual message element concurrently such that the grouped message element 750 is visually distinguishable from the individual message element. The displaying the grouped message element 750 by the first client device 102 may comprise displaying the portion of the most recent email 754 within the group of emails 1260, the displaying the individual message element comprises displaying a portion of the individual email.

In some embodiments, displaying the first individual message element 760 by the first client device 102 may comprise displaying the portion of the first individual email 764. Displaying the second individual message element 770 by the first client device 102 may comprise displaying the portion of the second individual email 774.

Further, the first client device 102 executing the method 1300 may furnish a hybrid form of communication (between emails and instant messaging) that has a positive effect on user experience of the user 101 during information exchange with the user 105, for example. The method 1300 may allow the reconciliation of different communicational platforms for providing advantages of email communication and instant message communication to the user 101.

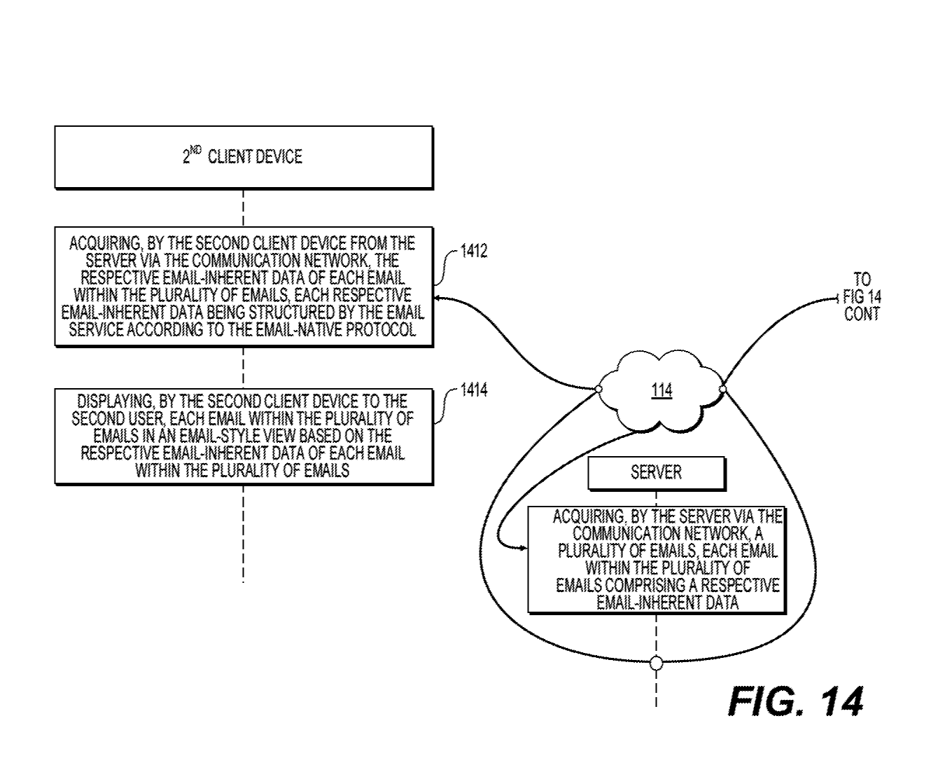

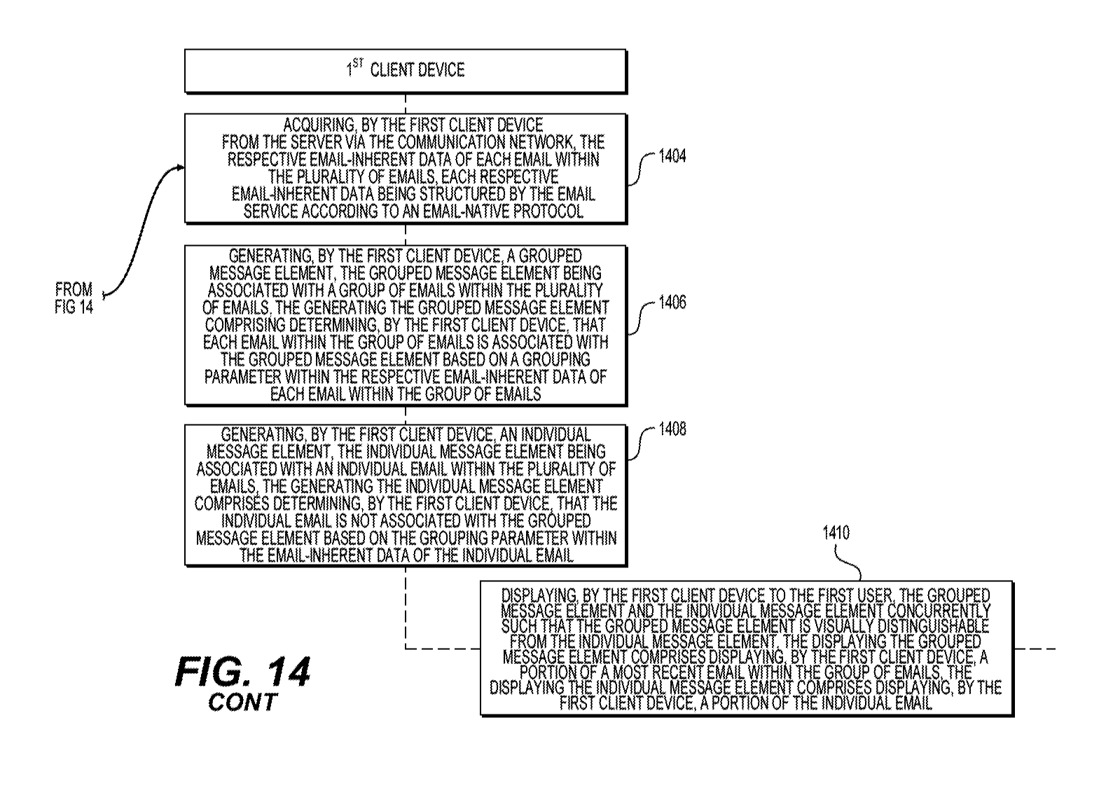

In some embodiments of the present technology, the system 100 may execute a method 1400 of processing emails and depicted in FIG. 14. As previously alluded to, the system 100 may comprise the server 116 hosting the email service and connected to the communication network 114, the first client device 102 associated with the user 101, the second client device 103 associated with the user 105 and the communication network 114 which is connected to the server 116, the first client device 102 and the second client device 103. The method 1400 will be further described below.

Step 1402: Acquiring by the Server a Plurality of Emails

The method 1400 begins at step 1402 with the server 116 acquiring via the communication network 114 the plurality of emails 1250 wherein each email within the plurality of emails 1250 comprises the respective email-inherent data.

In some embodiments, the server 116 may acquire the inbound emails within the plurality of emails 1250 via the communication network 114 from the second client device 103. The server 116 may acquire the outbound emails within the plurality of emails 1250 via the communication network 114 from the first client device 102. In other words, the server 116 may acquire the respective email-inherent data of the inbound emails within the plurality of emails 1250 via the communication network 114 from the second client device 103. The server 116 may acquire the respective email-inherent data of the outbound emails within the plurality of emails 1250 via the communication network 114 from the first client device 102.

In other embodiments, the respective email-inherent data of each email within the plurality of emails 1250 may be stored within the database 118. In this case, the server 116 may acquire the plurality of emails 1250 from the database 118.

Step 1404: Acquiring by the First Client Device the Plurality of Emails

The method 1400 continues to step 1404 with the first client device 102 acquiring from the server 116 via the communication network 114 the respective email-inherent data of each email within the plurality of emails 1250 wherein each respective email-inherent data is structured by the email service according to the email-native protocol.

In some embodiments, the respective email-inherent data may be structured by the email service implemented by the server 116 according to the SMTP. In other embodiments, the respective email-inherent data may be structured by the email service implemented by the server 116 according to the XMPP.

For example, the first client device 102 may acquire the respective email-inherent data of each email within the plurality of emails 1250 via the first signal 150. In other embodiments, the first signal 150 may further comprise information for triggering the first client device 102 to execute steps 1406, 1408 and 1410 of the method 1400.

Step 1406: Generating by the First Client Device the Group Message Element

The method 1400 continues to the step 1406 with the first client device 102 generating the grouped message element 750 wherein the grouped message element 750 is associated with the group of emails 1260 within the plurality of emails 1250. The generating the grouped message element 750 may comprise determining that each email within the group of emails 1260 is associated with the grouped message element 750 based on the grouping parameter within the respective email-inherent data of each email within the group of emails 1260.

In some embodiments of the present technology, the first client device 102 may be configured to generate the grouped message element 750. In this case, the first signal 150 may comprise the information for triggering the first client device 102 to generate the grouped message element 750.

Step 1408: Generating by the First Client Device the Individual Message Element

The method 1400 continues to the step 1408 with the first client device 102 generating the individual message element being associated with the individual email within the plurality of emails 1250. The generating the individual message element may comprise determining, by the first client device 102, that the individual email is not associated with the grouped message element 750 based on the grouping parameter within the email-inherent data of the individual email.

In some embodiments of the present technology, the first client device 102 may be configured to generate the individual message element. In this case, the first signal 150 may comprise the information for triggering the first client device 102 to generate the individual message element.

In other embodiments, the first client device 102 may generate the first individual message element 760 and the second individual message element 770, wherein the first individual message element 760 is associated with the first individual email within the plurality of emails 1250 and the second individual message element 770 is associated with the second individual email within the plurality of emails 1250.

Step 1410: Displaying by the First Client Device the Grouped Message Element and the Individual Message Element Concurrently

The method 1400 continues to the step 1410 with the first client device 102 displaying the grouped message element 750 and the individual message element concurrently such that the grouped message element 750 is visually distinguishable from the individual message element. The displaying the grouped message element 750 may comprise the first client device 102 displaying the portion of the most recent email within the group of emails 1260. The displaying the individual message element may comprise the first client device 102 displaying the portion of the individual email.

In some embodiments of the present technology, the first client device 102 may be configured to display the grouped message element 750 and the individual message element concurrently. In this case, the first signal 150 may comprise the information for triggering the first client device 102 to display the grouped message element 750 and the individual message element concurrently.

In other embodiments, the first client device 102 may display the grouped message element 750, the first individual message element 760 and the second individual message element 770 concurrently. To this end, the first signal 150 may comprise the information for triggering the first client device 102 to display the grouped message element 750, the first individual message element 760 and the second individual message element 770 concurrently.

Step 1412: Acquiring by the Second Client Device the Plurality of Emails

The method 1400 continues to step 1412 with the second client device 103 acquiring from the server 116 via the communication network 114, the respective email-inherent data of each email within the plurality of emails 1250, wherein each respective email-inherent data is structured by the email service according to the email-native protocol.

For example, the respective email-inherent data may be structured by the email service implemented by the server 116 according to the SMTP. In other words, the respective email-inherent data of each email within the plurality of emails 1250 acquired by the second client device 103 may be structured by the email service in a similar or identical manner then the respective email-inherent data of each email within the plurality of emails 1250 acquired by the first client device 102 at the step 1404.

In some embodiments, the second client device 103 may acquire the respective email-inherent data of each email within the plurality of emails 1250 via an additional signal. In other embodiments, the additional signal may be identical to the first signal 150 sent by the server 116 to the first client device 102.

It should be noted that emails within the plurality of emails 1250 corresponding to outbound emails with respect to the user 101 may correspond to inbound emails with respect to the user 105. For example, a given email sent by the user 101 to the user 105 corresponds to a given outbound email with respect to the user 101. The given email sent by the user 101 to the user 105 may correspond to a given inbound email with respect to the user 105. Similarly, the emails within the plurality of emails 1250 corresponding to inbound emails with respect to the user 101 may correspond to outbound emails with respect to the user 105.

Step 1414: Displaying by the Second Client Device Each Email in an Email-Style View

The method 1400 ends at step 1414 with the second client device 103 displaying each email within the plurality of emails 1250 in the respective email-style view based on the respective email-inherent data of each email within the plurality of emails 1250.

In some embodiments of the present technology, the second client device 103 may not be configured to generate and display the grouped message element 750 as well as the individual message element. In this case, the second client device 103 may display the first email 1201 in the email-style view 200 of the first email 1201, the second email 1203 in the email-style view 300 of the second email 1203, the third email 1205 in the email-style view 400 of the third email 1205, the fourth email 1207 in the email-style view 500 of the fourth email 1207 and the fifth email 1209 in the email-style view 600 of the fifth email 1209.

In other words, each given email within the plurality of emails 1250 may be displayed in the messenger-style view by the first client device 102 and/or in the respective email style view by the second client device 103.

In another embodiment, the first client device 102 may execute the first email application 104 with the first email interface 106 being of a first type of email interface. The second client device 103 may execute the second email application 108 with the second email interface 110 being of a second type of email interface. The first type of email interface may be a messenger-style interface and the second type of email interface may be an email-style interface.

In some embodiments, the server 116 may host the plurality of emails 1250, wherein any given e-mail within the plurality of e-mails 1250 may be a first outgoing e-mail from the first client device 102 to the second client device 103 and (ii) a second outgoing e-mail from the second client device 103 to the first client device 102, such that (i) the first outgoing e-mail from the first client device 102 to the second client device 103 is a first incoming e-mail from the first client device 102 to the second client device 103 and (ii) the second outgoing e-mail from the second client device 103 to the first client device 102 is a second incoming e-mail from the second client device 103 to the first client device 102. Each email within the plurality of emails 1250 may comprise the respective email-inherent data wherein each email-inherent data may be structured by the email service according to the email-native protocol.

In some embodiments, in response to a request (not depicted) by the first client device 102 to the server 116, the server 116 may transmit via the communication network 114 at least a portion (not depicted) of the plurality of emails 1250, the portion including at least one first outgoing e-mail and at least one second incoming message.

As a result, the first client device 102 may generate the grouped message element 750 which is associated with the group of emails 1260 within the plurality of emails 1250. In order to generate the grouped message element 750, the first client device 102 may determine that each email within the group of emails 1260 is associated with the grouped message element 750 based on the grouping parameter within the respective email-inherent data of each email within the group of emails 1260.

Further, the first client device 102 may generate the individual message element (such as the first individual message element 760 and/or the second individual message element 770) which is associated with the individual email within the plurality of emails 1250. In order to generate the individual message element, the first client device 102 may determine that the individual email is not associated with the grouped message element 750 based on the grouping parameter within the email-inherent data of the individual email.

In some embodiments, the first client device 102 may display to the user 101 the grouped message element 750 and the individual message element (such as the first individual message element 760 and/or the second individual message element 770) concurrently such that the grouped message element 750 is visually distinguishable from the individual message element. Displaying the grouped message element 750 by the first client device 102 may comprise displaying the portion of the most recent email 754 within the group of emails 1260. Displaying the individual message element by the first client device 102 may comprise displaying the portion of the individual email (such as the portion of the first individual email 764 and/or the portion of the second individual email 774).

In other embodiments, in response to a request (not depicted) by the second client device 103 to the server 116, the server 116 may transmit via the communication network 114 at least the portion of the plurality of emails 1250, the portion including at least one second outgoing e-mail and at least one first incoming message.

As a result, the second client device 103 may display to the user 105 each email within the plurality of email 1250 in the respective email-style view based on the respective email-inherent data of each email within the plurality of emails.

It should be expressly understood that not all technical effects mentioned herein need to be enjoyed in each and every embodiment of the present technology. For example, embodiments of the present technology may be implemented without the user enjoying some of these technical effects, while other embodiments may be implemented with the user enjoying other technical effects or none at all.

Modifications and improvements to the above-described implementations of the present technology may become apparent to those skilled in the art. The foregoing description is intended to be exemplary rather than limiting. The scope of the present technology is therefore intended to be limited solely by the scope of the appended claims.

Within the present description it should be understood that in all places where indicated the receiving data from any electronic device and/or from any email server and/or from any other server, the receiving of electronic or any other signal from suitable electronic device (server, email server) can be used, and the displaying on the device screen can be implemented as the transmission the signal to the display comprising certain information which further can be interpreted in a certain way and at least partially displayed on the screen of the electronic device. Transmitting and receiving of the signal are not mentioned everywhere within present description to simplify the description and for a better understanding of present solution. Signals can be transmitted by optical methods (for example, via fiber-optic connection), by electronic methods (via wired or wireless connection), by mechanical methods (transmitting of the pressure, temperature and/or other physical parameters by means of which the transmission of the signal is possible)

As such, from one perspective, embodiments of the present technology described above can be summarized as follows, structured in numbered clauses.

CLAUSE 1. A method (1300) of processing emails, the method (1300) being executed on a client device (102), the client device (102) being connected to a server (116), the server (116) hosting an email service, the method (1300) comprising:
acquiring (1302), by the client device (102), a plurality of emails (1250) from the server (116), each email within the plurality of emails (1250) comprising a respective email-inherent data, each email-inherent data being structured by the email service according to an email-native protocol;
generating (1304), by the client device (102), a grouped message element (750), the grouped message element (750) being associated with a group of emails (1260) within the plurality of emails (1250), the generating (1304) the grouped message element (750) comprising determining, by the client device (102), that each email within the group of emails (1260) is associated with the grouped message element (750) based on a grouping parameter within the respective email-inherent data of each email within the group of emails (1260);
generating (1306), by the client device (102), an individual message element (760), the individual message element (760) being associated with an individual email within the plurality of emails (1250), the generating (1306) the individual message element (760) comprises determining, by the client device (102), that the individual email is not associated with the grouped message element (750) based on the grouping parameter within the email-inherent data of the individual email;
displaying (1308), by the client device (102), the grouped message element (750) and the individual message element (760) concurrently such that the grouped message element (750) is visually distinguishable from the individual message element (760), the displaying the grouped message element (750) comprises displaying a portion of a most recent email within the group of emails (1260), the displaying the individual message element (760) comprises displaying a portion of the individual email.

CLAUSE 2. The method (1300) of clause 1, the grouped message element (750) being expandable for displaying a portion of each email within the group of emails (1260) associated with the grouped message element (750).

CLAUSE 3. The method (1300) of clause 2, wherein the plurality of emails (1250) comprises inbound emails and outbound emails, and wherein the group of emails (1260) comprises an inbound email and an outbound email, the displaying the portion of each email within the group of emails (1260) comprises displaying, by the client device (102), a portion of the inbound and the outbound email within the group of emails (1260) such that the portion of the inbound email is visually distinguishable from the portion of the outbound email.

CLAUSE 4. The method (1300) of clause 3, wherein the inbound emails are emails destined to a user (101) of the email service and the outbound emails are emails originated from the user (101) of the email service.

CLAUSE 5. The method (1300) of clause 1, wherein the email-native protocol is Simple Mail Transfer Protocol.

CLAUSE 6. The method (1300) of clause 1, wherein the determining that the group of emails (1260) within the plurality of emails (1250) are associated with the grouped message element (750) based on the grouping parameter comprises determining, by the client device (102), the grouping parameter within the respective email-inherent data of each email within the group of emails (1260).

CLAUSE 7. The method (1300) of clause 6, wherein the determining that the group of emails (1260) within the plurality of emails (1250) are associated with the grouped message element (750) based on the grouping parameter further comprises parsing, by the client device (102), the respective email-inherent data of each email within the group of emails (1260).

CLAUSE 8. The method (1300) of clause 4, wherein the determining that the group of emails (1260) within the plurality of emails (1250) is associated with the grouped message element (750) is executed by the user (101).

CLAUSE 9. The method (1300) of clause 4, wherein the determining that the individual email within the plurality of emails (1250) is associated with the individual message element (760) is executed by the user (101).

CLAUSE 10. A method (1400) of processing emails, the method (1400) executed in a system (100), the system (100) including:
a communication network (114);
a server (116) hosting an email service, the server (116) being connected to the communication network (114);
a first client device (102) associated with a first user (101) of the email service, the first client device (102) being connected to the communication network (114); and
a second client device (103) associated with a second user (105) of the email service, the second client device (103) being connected to the communication network (114);
   the method (1400) comprising:
acquiring (1402), by the server (116) via the communication network (114), a plurality of emails (1250), each email within the plurality of emails (1250) comprising a respective email-inherent data;
acquiring (1404), by the first client device (102) from the server (116) via the communication network (114), the respective email-inherent data of each email within the plurality of emails (1250), each respective email-inherent data being structured by the email service according to an email-native protocol;
generating (1406), by the first client device (102), a grouped message element (750), the grouped message element (750) being associated with a group of emails (1260) within the plurality of emails (1250), the generating (1406) the grouped message element (750) comprising determining, by the first client device (102), that each email within the group of emails (1260) is associated with the grouped message element (750) based on a grouping parameter within the respective email-inherent data of each email within the group of emails (1260);
generating (1408), by the first client device (102), an individual message element (760), the individual message element (760) being associated with an individual email within the plurality of emails (1250), the generating (1408) the individual message element (760) comprises determining, by the first client device (102), that the individual email is not associated with the grouped message element (750) based on the grouping parameter within the email-inherent data of the individual email;
displaying (1410), by the first client device (102) to the first user (101), the grouped message element (750) and the individual message element (760) concurrently such that the grouped message element (750) is visually distinguishable from the individual message element (760), the displaying the grouped message element (750) comprises displaying, by the first client device (102), a portion of a most recent email within the group of emails (1260), the displaying the individual message element (760) comprises displaying, by the first client device (102), a portion of the individual email;
acquiring (1412), by the second client device (103) from the server (116) via the communication network (114), the respective email-inherent data of each email within the plurality of emails (1250), each respective email-inherent data being structured by the email service according to the email-native protocol; and
displaying (1414), by the second client device (103) to the second user (105), each email within the plurality of emails (1250) in a respective email-style view based on the respective email-inherent data of each email within the plurality of emails (1250).

CLAUSE 11. A client device (102) for processing emails, the client device (102) being connected to a server (116), the server (116) hosting an email service, the client device (102) being configured to execute the method (1400) from clauses 1 to 9.

CLAUSE 12. A method of processing emails, the method executed in a system (100), the system (100) including:
a communication network (114);
a server (116) hosting an email service, the server (116) being connected to the communication network (114);
a first client device (102) associated with a first user (101) of the email service, the first client device (102) being connected to the communication network (114), the first client device (102) executing an e-mail interface of a first type (106); and
a second client device (103) associated with a second user (105) of the email service, the second client device (103) being connected to the communication network (114), the second client device (114) executing an e-mail interface of a second type (110);
   the first type being of a messenger style and the second type being of an e-mail style;
the method comprising:
   hosting, a plurality of emails (1250), any given e-mail within the plurality of e-mails (1250) being (i) a first outgoing e-mail from the first client device (102) to the second client device (103) and (ii) a second outgoing e-mail from the second client device (103) to the first client device (102), such that (i) the first outgoing e-mail from the first client device (102) to the second client device (103) is a first incoming e-mail from the first client device (102) to the second client device (103) and (ii) the second outgoing e-mail from the second client device (103) to the first client device (102) is a second incoming e-mail from the second client device (103) to the first client device (102), each email within the plurality of emails (1250) comprising a respective email-inherent data, each respective email-inherent data being structured by the email service according to an email-native protocol;
   in response to a request by the first client device (102), transmitting via the communication network (114) at least a portion of the plurality of e-mails (1250), the portion including at least one first outgoing e-mail and at least one second incoming message, said transmitting causing the first client device (102) to execute:
      generating, by the first client device (102), a grouped message element (750), the grouped message element (750) being associated with a group of emails (1260) within the plurality of emails (1250), the generating the grouped message element (750) comprising determining, by the first client device (102), that each email within the group of emails (1260) is associated with the grouped message element (750) based on a grouping parameter within the respective email-inherent data of each email within the group of emails (1260);
      generating, by the first client device (102), an individual message element, the individual message element being associated with an individual email within the plurality of emails (1250), the generating the individual message element comprises determining, by the first client device (102), that the individual email is not associated with the grouped message element (750) based on the grouping parameter within the email-inherent data of the individual email;
      displaying, by the first client device (102) to the first user (101), the grouped message element (750) and the individual message element concurrently such that the grouped message element (750) is visually distinguishable from the individual message element, the displaying the grouped message element (750) comprises displaying, by the first client device (102), a portion of a most recent email (754) within the group of emails (1260), the displaying the individual message element comprises displaying, by the first client device (102), a portion of the individual email;
   in response to a request by the second client device (103), transmitting via the communication network (114) at least a portion of the plurality of e-mails (1250), the portion including at least one second outgoing e-mail and at least one first incoming message, said transmitting causing the second client device (103) to execute:
      displaying, by the second client device (103) to the second user (105), each email within the plurality of emails (1250) in a respective email-style view based on the respective email-inherent data of each email within the plurality of emails (1250).

1. A method of processing emails, the method being executed on a client device, the client device being connected to a server, the server hosting an email service, the method comprising:
acquiring, by the client device, a plurality of emails from the server, each email within the plurality of emails comprising a respective email-inherent data, each email-inherent data being structured by the email service according to an email-native protocol;
generating, by the client device, a grouped message element, the grouped message element being associated with a group of emails within the plurality of emails, the generating the grouped message element comprising determining, by the client device, that each email within the group of emails is associated with the grouped message element based on a grouping parameter within the respective email-inherent data of each email within the group of emails;
generating, by the client device, an individual message element, the individual message element being associated with an individual email within the plurality of emails, the generating the individual message element comprises determining, by the client device, that the individual email is not associated with the grouped message element based on the grouping parameter within the email-inherent data of the individual email; and
displaying, by the client device, the grouped message element and the individual message element concurrently such that the grouped message element is visually distinguishable from the individual message element, the displaying the grouped message element comprises displaying a portion of a most recent email within the group of emails, the displaying the individual message element comprises displaying a portion of the individual email.

2. The method of claim 1, the grouped message element being expandable for displaying a portion of each email within the group of emails associated with the grouped message element.

3. The method of claim 2, wherein the plurality of emails comprises inbound emails and outbound emails, and wherein the group of emails comprises an inbound email and an outbound email, the displaying the portion of each email within the group of emails comprises displaying, by the client device, a portion of the inbound and the outbound email within the group of emails such that the portion of the inbound email is visually distinguishable from the portion of the outbound email.

4. The method of claim 3, wherein the inbound emails are emails destined to a user of the email service and the outbound emails are emails originated from the user of the email service.

5. The method of claim 1, wherein the email-native protocol is Simple Mail Transfer Protocol.

6. The method of claim 1, wherein the determining that the group of emails within the plurality of emails are associated with the grouped message element based on the grouping parameter comprises determining, by the client device, the grouping parameter within the respective email-inherent data of each email within the group of emails.

7. The method of claim 6, wherein the determining that the group of emails within the plurality of emails are associated with the grouped message element based on the grouping parameter further comprises parsing, by the client device, the respective email-inherent data of each email within the group of emails.

8. The method of claim 4, wherein the determining that the group of emails within the plurality of emails is associated with the grouped message element is executed by the user.

9. The method of claim 4, wherein the determining that the individual email within the plurality of emails is associated with the individual message element is executed by the user.

10. A method of processing emails, the method executed in a system, the system including:
a communication network;
a server hosting an email service, the server being connected to the communication network;
a first client device associated with a first user of the email service, the first client device being connected to the communication network; and
a second client device associated with a second user of the email service, the second client device being connected to the communication network;
the method comprising:
acquiring, by the server via the communication network, a plurality of emails, each email within the plurality of emails comprising a respective email-inherent data;
acquiring, by the first client device from the server via the communication network, the respective email-inherent data of each email within the plurality of emails, each respective email-inherent data being structured by the email service according to an email-native protocol;
generating, by the first client device, a grouped message element, the grouped message element being associated with a group of emails within the plurality of emails, the generating the grouped message element comprising determining, by the first client device, that each email within the group of emails is associated with the grouped message element based on a grouping parameter within the respective email-inherent data of each email within the group of emails;
generating, by the first client device, an individual message element, the individual message element being associated with an individual email within the plurality of emails, the generating the individual message element comprises determining, by the first client device, that the individual email is not associated with the grouped message element based on the grouping parameter within the email-inherent data of the individual email;
displaying, by the first client device to the first user, the grouped message element and the individual message element concurrently such that the grouped message element is visually distinguishable from the individual message element, the displaying the grouped message element comprises displaying, by the first client device, a portion of a most recent email within the group of emails, the displaying the individual message element comprises displaying, by the first client device, a portion of the individual email;
acquiring, by the second client device from the server via the communication network, the respective email-inherent data of each email within the plurality of emails, each respective email-inherent data being structured by the email service according to the email-native protocol; and
displaying, by the second client device to the second user, each email within the plurality of emails in a respective email-style view based on the respective email-inherent data of each email within the plurality of emails.

11. A client device for processing emails, the client device being connected to a server, the server hosting an email service, the client device being configured to:
acquire a plurality of emails from the server, each email within the plurality of emails comprising a respective email-inherent data, each email-inherent data being structured by the email service according to an email-native protocol;
generate a grouped message element, the grouped message element being associated with a group of emails within the plurality of emails, to generate the grouped message element comprises the client device being configured to determine that each email within the group of emails is associated with the grouped message element based on a grouping parameter within the respective email-inherent data of each email within the group of emails;
generate an individual message element, the individual message element being associated with an individual email within the plurality of emails, to generate the individual message element comprises the client device being configured to determine that the individual email is not associated with the grouped message element based on the grouping parameter within the email-inherent data of the individual email; and
display the grouped message element and the individual message element concurrently such that the grouped message element is visually distinguishable from the individual message element, to display the grouped message element comprises the client device being configured to display a portion of a most recent email within the group of emails, to display the individual message element comprises the client device being configured to display a portion of the individual email.

12. The client device of claim 11, wherein the grouped message element is expandable for displaying a portion of each email within the group of emails associated with the grouped message element.

13. The client device of claim 12, wherein the plurality of emails comprises inbound emails and outbound emails, and wherein the group of emails comprises an inbound email and an outbound email, to display the portion of each email within the group of emails comprises the client device being configured to display a portion of the inbound and the outbound email within the group of emails such that the portion of the inbound email is visually distinguishable from the portion of the outbound email.

14. The client device of claim 13, wherein the inbound emails are emails destined to a user of the email service and the outbound emails are emails originated from the user of the email service.

15. The client device of claim 11, wherein the email-native protocol is Simple Mail Transfer Protocol.

16. The client device of claim 11, wherein to determine that the group of emails within the plurality of emails are associated with the grouped message element based on the grouping parameter comprises the client device being configured to determine the grouping parameter within the respective email-inherent data of each email within the group of emails.

17. The client device of claim 16, wherein to determine that the group of emails within the plurality of emails are associated with the grouped message element based on the grouping parameter further comprises the client device being configured to parse the respective email-inherent data of each email within the group of emails.

18. The client device of claim 14, wherein to determine that the group of emails within the plurality of emails is associated with the grouped message element is executed by the user.

19. The client device of claim 14, wherein to determining that the individual email within the plurality of emails is associated with the individual message element is executed by the user.

20. A method of processing emails, the method executed in a system, the system including:
a communication network;
a server hosting an email service, the server being connected to the communication network;
a first client device associated with a first user of the email service, the first client device being connected to the communication network, the first client device executing an e-mail interface of a first type; and
a second client device associated with a second user of the email service, the second client device being connected to the communication network, the second client device executing an e-mail interface of a second type;
the first type being of a messenger style and the second type being of an e-mail style;
the method comprising:
hosting, a plurality of emails, any given e-mail within the plurality of e-mails being (i) a first outgoing e-mail from the first client device to the second client device and (ii) a second outgoing e-mail from the second client device to the first client device, such that (i) the first outgoing e-mail from the first client device to the second client device is a first incoming e-mail from the first client device to the second client device and (ii) the second outgoing e-mail from the second client device to the first client device is a second incoming e-mail from the second client device to the first client device, each email within the plurality of emails comprising a respective email-inherent data, each respective email-inherent data being structured by the email service according to an email-native protocol;
in response to a request by the first client device, transmitting via the communication network at least a portion of the plurality of e-mails, the portion including at least one first outgoing e-mail and at least one second incoming message, said transmitting causing the first client device to execute:
generating, by the first client device, a grouped message element, the grouped message element being associated with a group of emails within the plurality of emails, the generating the grouped message element comprising determining, by the first client device, that each email within the group of emails is associated with the grouped message element based on a grouping parameter within the respective email-inherent data of each email within the group of emails;
generating, by the first client device, an individual message element, the individual message element being associated with an individual email within the plurality of emails, the generating the individual message element comprises determining, by the first client device, that the individual email is not associated with the grouped message element based on the grouping parameter within the email-inherent data of the individual email;
displaying, by the first client device to the first user, the grouped message element and the individual message element concurrently such that the grouped message element is visually distinguishable from the individual message element, the displaying the grouped message element comprises displaying, by the first client device, a portion of a most recent email within the group of emails, the displaying the individual message element comprises displaying, by the first client device, a portion of the individual email;
in response to a request by the second client device, transmitting via the communication network at least a portion of the plurality of e-mails, the portion including at least one second outgoing e-mail and at least one first incoming message, said transmitting causing the second client device to execute:
displaying, by the second client device to the second user, each email within the plurality of emails in a respective email-style view based on the respective email-inherent data of each email within the plurality of emails.
